(19) United States
(12) Patent Application Publication
(10) Pub. No.: US 2024/0177697 A1
(43) Pub. Date: May 30, 2024

(54) AUDIO DATA PROCESSING METHOD AND APPARATUS, COMPUTER DEVICE, AND STORAGE MEDIUM

(71) Applicant: Tencent Technology (Shenzhen) Company Limited, Shenzhen (CN)

(72) Inventor: Xin FENG, Shenzhen (CN)

(21) Appl. No.: 18/431,811

(22) Filed: Feb. 2, 2024

Related U.S. Application Data
(63) Continuation of application No. PCT/CN23/98605, filed on Jun. 6, 2023.

(30) Foreign Application Priority Data
Jul. 28, 2022 (CN) 202210895424.3

(51) Int. Cl. G10H 1/00

(52) U.S. Cl. CPC G10H 1/0025; G10H 2210/041; G10H 2210/061

(57) ABSTRACT

This application provides an audio data processing method performed by a computer device. The method includes: dividing audio data into multiple sub-audios; separately performing time domain feature and frequency domain feature extraction on the multiple sub-audios to obtain time domain features and frequency domain features; performing feature fusion on the time domain features and frequency domain features corresponding to the multiple sub-audios, to obtain fusion features corresponding to the multiple sub-audios; performing semantic feature extraction based on the time domain features, frequency domain features, and the fusion features to obtain audio semantic features corresponding to the multiple sub-audios; determining each music segment from the multiple sub-audios based on the audio semantic features corresponding to the multiple sub-audios and a music semantic feature corresponding to the music segment; and performing music segment clustering based on the music semantic feature corresponding to each music segment, to obtain a same-type music segment set.

### CROSS-REFERENCE TO RELATED APPLICATIONS

This application is a continuation application of PCT Patent Application No. PCT/CN2023/098605, entitled “AUDIO DATA PROCESSING METHOD AND APPARATUS, COMPUTER DEVICE, AND STORAGE MEDIUM” filed on Jun. 6, 2023, which claims priority to Chinese Patent Application No. 2022108954243, entitled “AUDIO DATA PROCESSING METHOD AND APPARATUS, COMPUTER DEVICE, AND STORAGE MEDIUM” filed with the China National Intellectual Property Administration on Jul. 28, 2022, all of which is incorporated herein by reference in its entirety.

### FIELD OF THE TECHNOLOGY

This application relates to the field of computer technologies, and in particular, to an audio data processing method and apparatus, a computer device, a storage medium, and a computer program product.

### BACKGROUND OF THE DISCLOSURE

With development of an audio-video platform, an audio-video split collection technology appears. An audio-video split collection generally identifies audio segments of the same type in a long video, then splits audios-videos corresponding to the audio segments of the same type from the long video, and concatenates the audios-videos to obtain a collection of audios and videos of the same type. For example, multiple singing programs of the same singer in a festive gala video are split for collection. Currently, identification of audio segments of the same type is generally performed by inputting a long video and audio into an audio coding network, then outputting a coded feature vector sequence of the entire audio, then clustering the coded feature vector sequence of the entire audio, and clustering similar audio feature vectors into a cluster, so as to determine audio segments of the same type for splitting and collection. However, accuracy of a feature obtained by coding the entire audio is low, thereby reducing accuracy of identification of audio segments of the same type.

### SUMMARY

Therefore, for the foregoing technical problem, it is necessary to provide an audio data processing method and apparatus, a computer device, a computer readable storage medium, and a computer program product that can improve feature extraction accuracy, so as to improve accuracy of identification of audios of the same type.

According to a first aspect, this application provides an audio data processing method performed by a computer device. The method includes:
dividing audio data into multiple sub-audios;
separately extracting time domain features from the multiple sub-audios, the time domain features including an intermediate time domain feature and a target time domain feature;
separately extracting frequency domain features from the multiple sub-audios, the frequency domain features including an intermediate frequency domain feature and a target frequency domain feature;
performing feature fusion on intermediate time domain features corresponding to the multiple sub-audios and intermediate frequency domain features corresponding to the multiple sub-audios, to obtain fusion features corresponding to the multiple sub-audios;
performing semantic feature extraction based on target time domain features, target frequency domain features, and the fusion features that are corresponding to the multiple sub-audios, to obtain audio semantic features corresponding to the multiple sub-audios;
determining each music segment from the multiple sub-audios based on the audio semantic features corresponding to the multiple sub-audios and a music semantic feature corresponding to the music segment; and
performing music segment clustering based on the music semantic feature corresponding to each music segment, to obtain a same-type music segment set.

According to a second aspect, this application further provides a computer device. The computer device includes a memory and a processor, the memory stores computer readable instructions, and the processor implements the aforementioned method by executing the computer readable instructions.

According to a third aspect, this application further provides a non-transitory computer readable storage medium. The computer readable storage medium stores computer readable instructions that, when executed by a processor of the computer device, cause the computer device to implement the aforementioned method.

In the foregoing audio data processing method and apparatus, computer device, storage medium, and computer program product, audio data is divided into multiple sub-audios. Time domain feature extraction is separately performed on the multiple sub-audios to obtain intermediate time domain features and target time domain features, and frequency domain feature extraction is separately performed on the multiple sub-audios to obtain intermediate frequency domain features and target frequency domain features. Then feature fusion is performed on the intermediate time domain features and the intermediate frequency domain features that are corresponding to the multiple sub-audios, to obtain fusion features corresponding to the multiple sub-audios. Feature fusion not only enables the obtained fusion features to have complementary information between time domain and frequency domain, but also enables the fusion features to have information about an underlying feature. Then, semantic feature extraction is performed by using the target time domain features, the target frequency domain features, and the fusion features that are corresponding to the multiple sub-audios, to obtain audio semantic features corresponding to the multiple sub-audios, so that extracted audio semantic features can not only contain time domain information and frequency domain information, but also can greatly retain original audio characteristics. Then music classification and identification is performed based on the audio semantic features, to obtain music possibilities corresponding to the multiple sub-audios, thereby improving accuracy of music classification and identification. Then, each music segment is determined from the audio data based on the music possibilities, and a music semantic feature corresponding to each music segment is determined based on the audio semantic feature. Music segment classification and identification is performed based on the music semantic feature corresponding to each music segment, to obtain a same-type music segment set, thereby improving accuracy of performing music segment classification and identification, and further improving accuracy of obtaining a same-type music segment set.

### BRIEF DESCRIPTION OF THE DRAWINGS

To describe the technical solutions in the embodiments of this application more clearly, the following briefly introduces the accompanying drawings required for describing the embodiments. Apparently, the accompanying drawings in the following description show only some embodiments of this application, and a person skilled in the art may still derive other drawings from these accompanying drawings without creative efforts.

FIG. 1 is a diagram of an application environment of an audio data processing method according to an embodiment.

FIG. 2 is a schematic flowchart of an audio data processing method according to an embodiment.

FIG. 3 is a schematic flowchart of obtaining a same-type music segment set according to an embodiment.

FIG. 4 is a schematic diagram of a network architecture of a sequence transform model according to a specific embodiment.

FIG. 5 is a schematic diagram of classification and aggregation according to a specific embodiment.

FIG. 6 is a schematic diagram of spatial similarity calculation according to a specific embodiment.

FIG. 7 is a schematic flowchart of obtaining a target interaction feature according to an embodiment.

FIG. 8 is a schematic flowchart of obtaining a music possibility according to an embodiment.

FIG. 9 is a schematic flowchart of obtaining a music possibility according to another embodiment.

FIG. 10 is a schematic flowchart of obtaining a music possibility according to still another embodiment.

FIG. 11 is a schematic diagram of a network architecture of a music classification and identification model according to a specific embodiment.

FIG. 12 is a schematic flowchart of music classification and identification model training according to an embodiment.

FIG. 13 is a schematic flowchart of an audio data processing method according to a specific embodiment.

FIG. 14 is a schematic diagram of an application scenario of audio data processing according to a specific embodiment.

FIG. 15 is a schematic diagram of an effect of a same-type program collection according to a specific embodiment.

FIG. 16 is a structural block diagram of an audio data processing apparatus according to an embodiment.

FIG. 17 is an internal structural diagram of a computer device according to an embodiment.

FIG. 18 is an internal structural diagram of a computer device according to another embodiment.

### DESCRIPTION OF EMBODIMENTS

To make the objectives, technical solutions, and advantages of this application clearer, the following further describes this application in detail with reference to the accompanying drawings and the embodiments. It is to be understood that the specific embodiments described herein are only used for explaining this application, and are not used for limiting this application.

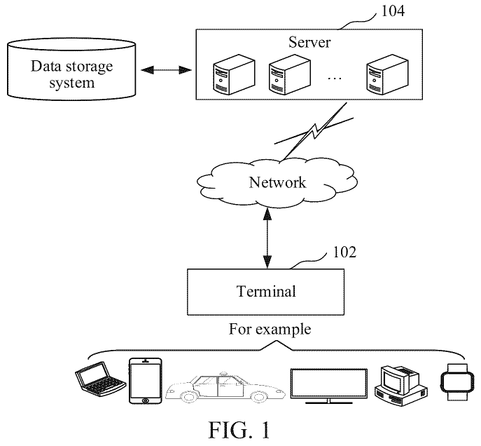

An audio data processing method provided in this embodiment of this application may be applied to an application environment shown in FIG. 1. A terminal 102 communicates with a server 104 by using a network. A data storage system may store data that needs to be processed by the server 104. The data storage system may be integrated on the server 104, or may be placed on cloud or another server. The server 104 may obtain audio data from the data storage system, and divide the audio data into multiple sub-audios. The server 104 separately extracts time domain features from the multiple sub-audios, the time domain features including an intermediate time domain feature and a target time domain feature; the server 104 separately extracts frequency domain features from the multiple sub-audios, the frequency domain features including an intermediate frequency domain feature and a target frequency domain feature. The server 104 performs feature fusion on intermediate time domain features corresponding to the multiple sub-audios and intermediate frequency domain features corresponding to the multiple sub-audios, to obtain fusion features corresponding to the multiple sub-audios; and performs semantic feature extraction based on target time domain features, target frequency domain features, and the fusion features that are corresponding to the multiple sub-audios, to obtain audio semantic features corresponding to the multiple sub-audios, and performs music classification and identification based on the audio semantic features, to obtain music possibilities corresponding to the multiple sub-audios. The server 104 determines each music segment from the audio data based on the music possibilities, and determines a music semantic feature corresponding to each music segment based on the audio semantic feature. The server 104 performs music segment classification and identification based on the music semantic feature corresponding to each music segment to obtain a same-type music segment set. The server 104 may send the same-type music segment set to the terminal 102 for presentation. The terminal 102 may be but is not limited to various personal computers, laptops, smartphones, tablet computers, Internet of Things devices, and portable wearable devices. The Internet of Things device may be an intelligent sound box, an intelligent television, an intelligent air conditioner, an intelligent in-vehicle device, or the like. The portable wearable device may be a smart watch, a smart band, a head-mounted device, or the like. The server 104 may be implemented by using an independent server or a server cluster that includes multiple servers or a cloud server.

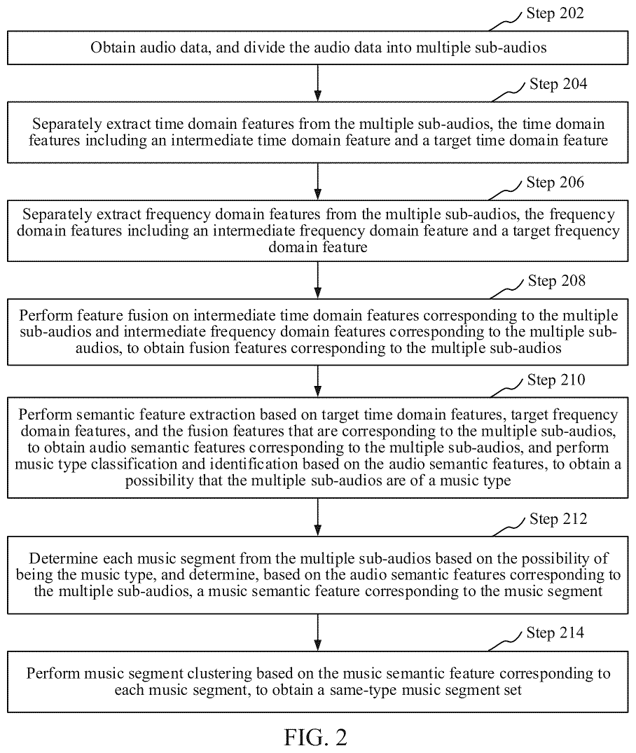

In an embodiment, as shown in FIG. 2, an audio data processing method is provided. An example in which the method is applied to the server in FIG. 1 is used for description. It may be understood that the method may be applied to a terminal, or may be applied to a system including a terminal and a server, and is implemented by means of interaction between the terminal and the server. In this embodiment, the method includes the following steps:

Step 202: Obtain audio data, and divide the audio data into multiple sub-audios.

The audio data refers to audio data that needs to be processed, and the audio data may be an original sequence of audio signals, for example, may be an audio sampling point sequence. The sub-audio refers to an audio segment in the audio data. For example, the sub-audio may be an audio frame. The multiple sub-audios may be at least two sub-audios.

Specifically, the server may obtain the audio data from a database. The server may obtain uploaded audio data from the terminal. The server may alternatively obtain the audio data from a service provider. The server may alternatively obtain audio data from a service provider that provides a data service. Then, the audio data is divided to obtain each sub-audio, where the audio data may be divided into frames, or may be segmented according to a preset time period or a preset quantity of samples to obtain each audio frame, and each audio frame is used as each sub-audio. For example, the server may obtain a preset frame length parameter and a frame shift parameter, then calculate a frame quantity according to the frame length parameter and the frame shift parameter, and divide the audio data according to the frame length parameter, the frame shift parameter, and the frame quantity to obtain multiple sub-audios.

Step 204: Separately extract time domain features from the multiple sub-audios, the time domain features including an intermediate time domain feature and a target time domain feature.

The time domain feature refers to a semantic feature used for representing sub-audio time domain information. The sub-audio time domain information refers to a time domain diagram corresponding to a sub-audio. A horizontal axis of the time domain diagram is time, a vertical axis is sound strength, and the time domain diagram measures a segment of audio from a time dimension. The intermediate time domain feature refers to a semantic feature extracted in a process of extracting the target time domain feature. The target time domain feature refers to a time domain feature corresponding to a finally extracted sub-audio.

Specifically, the server may perform multiple convolution operations on the sub-audios to obtain time domain features corresponding to the sub-audios, and convolutional parameters used in the convolution operations are different. Time domain feature extraction is performed by using multiple convolution operations, and a convolution result obtained after each convolution operation is an intermediate time domain feature. A result of the last convolution operation is a target time domain feature. That is, the server performs a convolution operation on the sub-audio for the first time to obtain an intermediate time domain feature, performs convolution on the intermediate time domain feature as an object of the next convolution operation to perform convolution until all convolution operations are completed, and uses a result of the last convolution operation as a target time domain feature. The convolution operation may be that correlation calculation is performed on sub-audio data and a convolution parameter, and the convolution parameter may be obtained from a preset parameter in the database. The server sequentially traverses the sub-audios, and performs time domain feature extraction on the sub-audios to obtain intermediate time domain features and target time domain features corresponding to the sub-audios.

Step 206: Separately extract frequency domain features from the multiple sub-audios, the frequency domain features including an intermediate frequency domain feature and a target frequency domain feature.

The frequency domain feature refers to a semantic feature used for representing frequency domain information of a sub-audio. The frequency domain information of the sub-audio refers to a frequency domain diagram corresponding to the sub-audio. A horizontal axis of the frequency domain diagram is a frequency, and a vertical axis is an energy size of a current frequency. The frequency domain diagram measures a segment of sound from a frequency distribution dimension. The intermediate frequency domain feature refers to a semantic feature extracted in a process of extracting the target frequency domain feature. The target frequency domain feature refers to a semantic feature of frequency domain corresponding to a finally extracted sub-audio.

Specifically, the server may also perform multiple convolution operations on the sub-audios to obtain frequency domain features corresponding to the sub-audios, and convolutional parameters used in the convolution operations are different. Frequency domain feature extraction is performed by using multiple convolution operations, and a convolution result obtained after each convolution operation is an intermediate frequency domain feature. A result of the last convolution operation is a target frequency domain feature. That is, the server performs a convolution operation on the sub-audio for the first time to obtain an intermediate frequency domain feature, and uses the intermediate frequency domain feature as an object of the next convolution operation to perform a convolution operation until all convolution operations are completed, and uses a result of the last convolution operation as a target frequency domain feature. Finally, the server sequentially traverses the sub-audios, that is, performs frequency domain feature extraction on the sub-audios to obtain intermediate frequency domain features and target frequency domain features corresponding to the sub-audios.

Step 208: Perform feature fusion on intermediate time domain features corresponding to the multiple sub-audios and intermediate frequency domain features corresponding to the multiple sub-audios, to obtain fusion features corresponding to the multiple sub-audios.

Feature fusion is used for performing audio information fusion between an intermediate time domain feature and a corresponding intermediate frequency domain feature, so as to improve robustness of audio identification, and extract a more advanced semantic information feature. The fusion feature refers to a semantic feature obtained by fusing audio time domain semantic information and audio frequency domain semantic information.

Specifically, the server performs fusion calculation by using an intermediate time domain feature and an intermediate frequency domain feature corresponding to a sub-audio to obtain a fusion feature corresponding to the sub-audio, where fusion may be performing concatenation between the intermediate time domain feature and the intermediate frequency domain feature, and fusion may alternatively be performing a vector operation on a vector corresponding to the intermediate time domain feature and a vector corresponding to the intermediate frequency domain feature. For example, a vector addition operation may be performed, a vector quantity product operation may be performed, and a vector product operation may be performed. Fusion may alternatively be performing concatenation between the intermediate time domain feature and the intermediate frequency domain feature, and further performing a convolution operation on a concatenation result. Finally, the server performs fusion calculation on the intermediate time domain feature and the intermediate frequency domain feature corresponding to each sub-audio to obtain a fusion feature corresponding to each sub-audio.

Step 210: Perform semantic feature extraction based on target time domain features, target frequency domain features, and the fusion features that are corresponding to the multiple sub-audios, to obtain audio semantic features corresponding to the multiple sub-audios, and perform music type classification and identification based on the audio semantic features, to obtain a possibility that the multiple sub-audios are of a music type.

The audio semantic feature refers to a semantic feature obtained after the target time domain feature, the target frequency domain feature, and the fusion feature are aggregated. The aggregation may be concatenating the target time domain feature, the target frequency domain feature, and the fusion feature, or may be performing a vector operation on a vector corresponding to the target time domain feature, a vector corresponding to the target frequency domain feature, and a vector corresponding to the fusion feature, or may be performing a convolution operation after concatenating the target time domain feature, the target frequency domain feature, and the fusion feature, where a convolution parameter for performing a convolution operation during aggregation is different from a convolution parameter for performing a convolution operation during fusion. Each sub-audio has a corresponding audio semantic feature. The audio semantic feature has more semantic information. Music type classification and identification refers to binary classification and identification for determining whether an audio is a music type audio, which includes music type audio and non-music type audio. The music type audio refers to an audio corresponding to music, and the non-music audio refers to an audio corresponding to voice except music. Music is an artistic form and a cultural activity, and a medium of the music is a regular sound wave (one type of mechanical wave) that is organized over time. The music is performed by using various musical instruments and vocal music technologies, and is divided into instrumental music, vocal music (for example, a song that is not accompanied by the musical instrument), and a work that concatenates singing and the musical instrument. The possibility of being the music type is used for representing a possibility that a corresponding sub-audio is an audio of the music type. A higher possibility of being the music type is, a higher possibility that the corresponding sub-audio is an audio of the music type is. A lower possibility of being the music type is, a higher possibility that the corresponding sub-audio is an audio of the non-music type is. The possibility may be a probability, may be a score, or the like.

Specifically, the server performs an audio semantic feature aggregation operation by using the target time domain feature, the target frequency domain feature, and a target interaction feature that are corresponding to each sub-audio to obtain a feature obtained after aggregating the semantic information, that is, to obtain an audio semantic feature corresponding to each sub-audio. Then, the server performs music binary classification and identification by using the audio semantic feature, and identifies whether the sub-audio is a music type audio or a non-music type audio, to obtain a music type possibility corresponding to each sub-audio, where the audio semantic feature is mapped to [0, 1] that represents an effective real space of probability distribution, to obtain a music type possibility corresponding to each sub-audio. For example, the audio semantic feature may be mapped by using a normalized index function, to obtain an outputted probability value, and the probability value is used as the music type possibility.

Step 212: Determine each music segment from the multiple sub-audios based on the possibility of being the music type, and determine, based on the audio semantic features corresponding to the multiple sub-audios, a music semantic feature corresponding to the music segment.

The music segment refers to an audio segment obtained by concatenating connected music type sub-audios, and the connection refers to time continuity. The music type sub-audio refers to a sub-audio whose possibility of being the music type exceeds a preset possibility threshold. The preset music possibility threshold is a preset probability threshold when a sub-audio is a music type audio, for example, may be a probability threshold, or may be a score threshold. The music semantic feature is used for representing semantic information of a music segment, and is obtained by concatenating audio semantic features corresponding to sub-audios included in each music segment.

Specifically, the server compares the possibility of being the music type corresponding to each sub-audio with the preset possibility threshold. When the possibility of being the music type exceeds the preset possibility threshold, the sub-audio corresponding to the possibility of being the music type is a music type audio. Then, music type audios that can be connected to the multiple sub-audios are concatenated into a music segment according to a time sequence, to obtain each music segment. For example, three sub-audios that have time continuity are music type audios. In this case, the three sub-audios are concatenated to obtain a music segment. The concatenation may be concatenating the sub-audios according to the time sequence. Then, audio semantic features corresponding to audios of the music type in the music segment are concatenated to obtain a music semantic feature corresponding to the music segment, and music semantic features corresponding to the music segments are obtained by traversing the music segments.

Step 214: Perform music segment clustering based on the music semantic feature corresponding to each music segment, to obtain a same-type music segment set.

A process of dividing a set of physical or abstract objects into multiple classes including similar objects is referred to as clustering. Music segment clustering is used for aggregating music segments of the same type. The same-type music segment set includes various same-type music segments, and the same-type music segments refer to music segments whose similarity exceeds a preset similarity threshold. For example, music segments whose similarity exceeds the preset similarity threshold may be different singing audio segments of the same person. Alternatively, music segments whose similarity exceeds the preset similarity threshold may be different music segments in same-type programs.

Specifically, the server clusters music segments by using the music semantic features corresponding to the music segments, to obtain at least one same-type music segment set. The server may cluster the music segments by calculating a similarity between the music semantic features, that is, a similarity algorithm may be used for calculating a similarity between music semantic features of different music segments. The similarity algorithm may be cosine similarity, Euclidean distance similarity, or the like. Alternatively, the server may cluster the music segments by using a neural network algorithm and the music semantic features corresponding to the music segments.

In the foregoing audio data processing method, the audio data is divided into multiple sub-audios. Time domain feature extraction is separately performed on the multiple sub-audios to obtain intermediate time domain features and target time domain features, and frequency domain feature extraction is separately performed on the multiple sub-audios to obtain intermediate frequency domain features and target frequency domain features. Then feature fusion is performed on the intermediate time domain features and the intermediate frequency domain features that are corresponding to the multiple sub-audios, to obtain fusion features corresponding to the multiple sub-audios. Feature fusion not only enables the obtained fusion features to have complementary information between time domain and frequency domain, but also enables the fusion features to have information about an underlying feature. Then, semantic feature extraction is performed by using the target time domain features, the target frequency domain features, and the fusion features that are corresponding to the multiple sub-audios, to obtain audio semantic features corresponding to the multiple sub-audios, so that extracted audio semantic features can not only contain time domain information and frequency domain information, but also can greatly retain original audio characteristics. Then music type classification and identification is performed based on the audio semantic features, to obtain music type possibilities corresponding to the sub-audios, thereby improving accuracy of music type classification and identification. Then, each music segment is determined from the multiple sub-audios based on the music type possibilities, and a music semantic feature corresponding to each music segment is determined based on the audio semantic feature. Music segment classification and identification is performed based on the music semantic feature corresponding to each music segment, to obtain a same-type music segment set, thereby improving accuracy of performing music segment clustering, and further improving accuracy of obtaining a same-type music segment set.

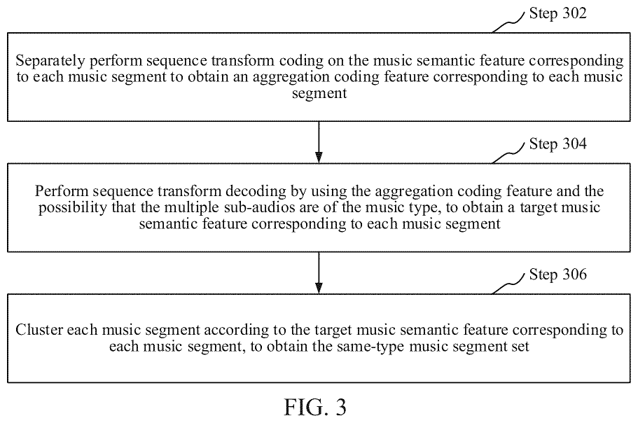

In an embodiment, as shown in FIG. 3, step 214 of performing music segment clustering based on the music semantic feature corresponding to each music segment, to obtain a same-type music segment set includes:

Step 302: Separately perform sequence transform coding on the music semantic feature corresponding to each music segment to obtain an aggregation coding feature corresponding to each music segment.

Sequence transform coding refers to coding by using a coding neural network in a sequence transform model. The sequence transform model may be established on the basis of a network architecture of a transformer (transformation model from one sequence to another sequence) model. The aggregation coding feature refers to a coding feature that aggregates semantic information in audio after sequence transform coding is performed.

Specifically, the server establishes an initial sequence transform model in advance, then trains an initial sequence transform parameter in the initial sequence transform model, and when the training is completed, obtains a sequence transform model. A training data set may be obtained from a server that provides a data service. The training data set includes training input data and training label data. The training input data is an untransformed feature vector sequence, and the training label data is a transformed feature vector sequence. The untransformed feature vector sequence is inputted into the initial sequence transform model to obtain an outputted initial transform feature vector sequence. Then, an error between the initial transform feature vector sequence and the training label data is calculated. Based on the error, the parameter in the initial sequence transform model is inversely updated to obtain an updated sequence transform model, and training iterations are continuously performed until a maximum quantity of iterations is reached or a model error is less than a preset threshold, to obtain a completely trained sequence transform model. In a specific embodiment, the server may directly obtain an open-source model parameter to obtain the sequence transform model.

The server sequentially performs sequence transform on the music semantic feature corresponding to each music segment to obtain a target music semantic feature corresponding to each music segment. The server obtains a music semantic feature corresponding to a current music segment that currently needs to perform sequence transform, where the music semantic feature is a feature that has time sequence information, and then inputs the music semantic feature corresponding to the current music segment into the feature sequence transform model and performs coding by using the coding neural network, to obtain an outputted aggregation coding feature. Then, the music semantic feature corresponding to each music segment is traversed to obtain an aggregation coding feature corresponding to each music segment.

Step 304: Perform sequence transform decoding by using the aggregation coding feature and the possibility that the multiple sub-audios are of the music type, to obtain a target music semantic feature corresponding to each music segment.

Sequence transform decoding refers to decoding by using a decoding neural network in the sequence transform model.

Specifically, the server sequentially selects, from multiple possibilities that the sub-audios are of the music type, a music type possibility of each sub-audio corresponding to a music segment that is currently to be decoded, and when the music segment is corresponding to at least two sub-audios, obtains a music type possibility of each sub-audio corresponding to the music segment; and then concatenates an aggregation coding feature corresponding to the current music segment and the music type possibility of each sub-audio corresponding to the current music segment, that is, inputs, as a feature vector into the decoding neural network of the sequence transform model for decoding, to obtain an outputted target music semantic feature corresponding to the current music segment. The aggregation coding feature may be used as a header and the music type possibility may be used as a tail for concatenation, or the aggregation coding feature may be used as a tail and the music type possibility may be used as a header for concatenation, to obtain a to-be-inputted feature vector. The server sequentially traverses the music segments to obtain target music semantic features corresponding to all the music segments.

Step 306: Cluster each music segment according to the target music semantic feature corresponding to each music segment, to obtain the same-type music segment set.

Specifically, the server may cluster, by using a clustering algorithm, the target music semantic feature corresponding to each music segment, to obtain each music segment obtained after clustering, and use music segments of each type as same-type music segments, to obtain a music segment set of the type. The clustering algorithm may be a prototype-based clustering algorithm, a density-based clustering algorithm, a hierarchy-based clustering algorithm, a neural network model-based clustering algorithm, or the like.

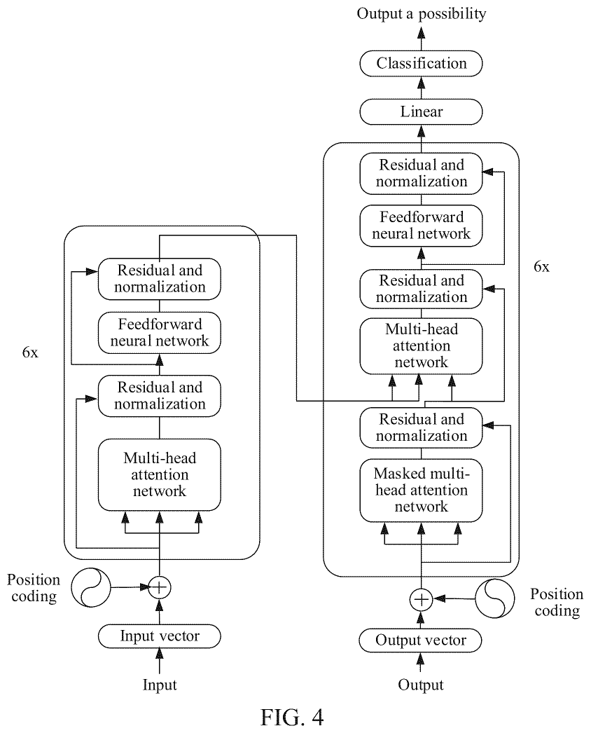

In a specific embodiment, as shown in FIG. 4, a schematic diagram of a network architecture of a sequence transform model is provided, where the sequence transform model includes a coding network and a decoding network, the coding network includes six encoders, and the decoding network includes six decoders. The encoder includes a multi-head attention network and a feedforward neural network, the decoder includes a masked multi-head attention network, a multi-head attention network, and a feedforward neural network, and the neural networks are connected by residuals and normalization. The music semantic feature corresponding to each music segment is inputted into the coding network for coding, to obtain an outputted aggregation coding feature corresponding to each music segment, and then the aggregation coding feature corresponding to each music segment and the music possibility corresponding to each sub-audio are inputted into the decoding network for decoding, to obtain the target music semantic feature corresponding to each music segment. That is, the music possibility corresponding to each sub-audio is used as a common input to the decoding network, so that information about a music classification result can be learned directly, thereby improving semantic representation of a feature vector outputted by the sequence transform model, and increasing a spatial distance between different music segments.

In an embodiment, step 302 of separately performing sequence transform coding on the music semantic feature corresponding to each music segment to obtain an aggregation coding feature corresponding to each music segment includes the following steps:
extracting basic audio features corresponding to the multiple sub-audios, and determining, from the basic audio features corresponding to the multiple sub-audios, a music segment basic feature corresponding to each music segment; separately concatenate the music segment basic feature corresponding to each music segment with the music semantic feature corresponding to each music segment, to obtain a target fusion feature corresponding to each music segment; and input the target fusion feature corresponding to each music segment to a coding network of a sequence transform model for coding, to obtain an outputted target aggregation coding feature corresponding to each music segment.

The basic audio feature refers to a feature of an audio basic, may be a frequency domain spectrum obtained by means of calculation by using a mel frequency, and the frequency domain spectrum is used as the basic audio feature. The mel frequency is a non-linear frequency scale determined based on sensory determining of an equidistant pitch change by human cars, is an artificially set frequency scale that can more cater to a change of an auditory perception threshold of the human ears when signal processing is performed. The basic audio feature may further include a sampling frequency, a bit rate, a quantity of channels, a frame rate, a zero cross counter, a short-term autocorrelation coefficient, a short time energy, and the like. The basic feature of the music segment refers to a basic audio feature corresponding to the music segment, and is obtained by concatenating basic audio features of sub-audios corresponding to the music segment. The target fusion feature refers to a music semantic feature obtained after basic information is fused. The feature may be represented in a form of a vector sequence. The target aggregation coding feature refers to an aggregation coding feature obtained after basic information is fused.

Specifically, the server extracts a basic audio feature corresponding to each sub-audio, and may calculate a frequency domain spectrum, calculate a sampling frequency, a bit rate, a quantity of channels, a frame rate, a zero cross counter, a short-term autocorrelation coefficient, short time energy, and the like. Then, the calculated frequency domain spectrum, sampling frequency, bit rate, quantity of channels, frame rate, zero cross counter, short-term autocorrelation coefficient, and short time energy are used as the basic audio features. Then the server concatenates the basic audio features of the sub-audios corresponding to each music segment to obtain the music segment basic audio feature corresponding to each music segment. The server may perform head-to-tail concatenation on the basic audio features of the sub-audios corresponding to each music segment. Then, the music segment basic feature corresponding to each music segment and the music semantic feature corresponding to each music segment are concatenated head-to-tail to obtain a target fusion feature corresponding to each music segment, and finally, the target fusion feature corresponding to each music segment is successively inputted into the parameter in the coding network of the sequence transform model for coding to obtain an outputted target aggregation coding feature.

In the foregoing embodiment, coding is separately performed after a music segment basic feature is concatenated with a corresponding music semantic feature, which can further improve accuracy of an outputted target aggregation coding feature, and further improve accuracy of an obtained target music semantic feature.

In an embodiment, step 306 of clustering each music segment according to the target music semantic feature corresponding to each music segment, to obtain the same-type music segment set includes the following steps:
calculating a spatial similarity between the music segments by using the target music semantic feature corresponding to each music segment; and performing classification and aggregation on each music segment according to the spatial similarity between the music segments, to obtain the same-type music segment set.

The spatial similarity is also referred to as a spatial distance, and the spatial similarity is measured by measuring a cosine value of an included angle between two vectors. A cosine value of a spatial 0-degree angle is 1, and a cosine value of any other angle is not greater than 1, and its minimum value is −1. Therefore, a cosine value of an angle between two vectors determines a spatial similarity between the two vectors, that is, a coincidence degree between the spatial angle and directions of the two vectors. When two vectors have the same direction, and a similarity is high, a value of a cosine similarity is 1. When a spatial included angle between two vectors is 90°, and a similarity is low, a value of a cosine similarity is 0. When two vectors point in exactly opposite directions and are completely dissimilar, a value of a cosine similarity is −1. This result is independent of a length of a vector and is only related to a pointing direction of the vector. The cosine similarity is usually used in a positive space, so that a given value is between 0 and 1.

Specifically, the server performs calculation in a pair by using the target music semantic features corresponding to each music segment, that is, selects a first target music semantic feature and a second target music semantic feature from the target music semantic features corresponding to each music segment without replacement; then calculates a spatial similarity between the first target music semantic feature and the second target music semantic feature; the server traverses and calculates spatial similarities between all target music semantic features; then performs classification and aggregation on all spatial similarities; and aggregates, into the same set, music segments corresponding to target music semantic features whose spatial similarities exceed a preset threshold, to obtain a same-type music segment set.

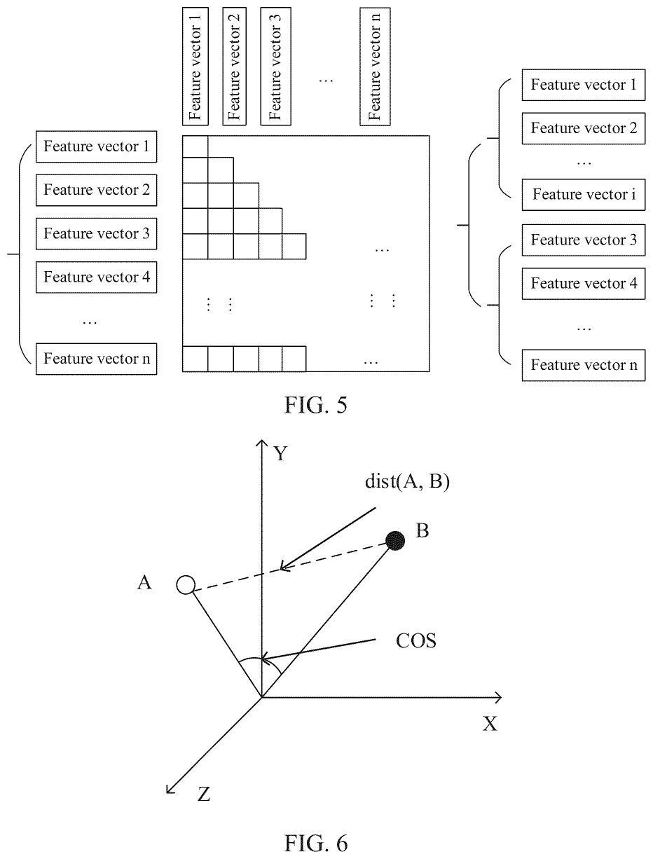

In a specific embodiment, as shown in FIG. 5, it is a schematic diagram of performing classification and aggregation by using a spatial similarity. Feature vectors corresponding to n target music semantic features corresponding to n (positive integer) music segments are obtained, and then a spatial similarity is calculated in pair. As shown in FIG. 6, it is a schematic diagram of spatial similarity calculation. According to the schematic diagram, it can be seen whether directions of two target music semantic feature vectors in space are consistent, and spatial similarity measurement can be performed on the two vectors by calculating a cosine included angle. The spatial similarity may be calculated by using a formula (1).

$$dist ( A , B ) = 1 - cos ( A , B ) = \frac{{‖ A ‖}_{2} {‖ B ‖}_{2} - A \cdot B}{{‖ A ‖}_{2} {‖ B ‖}_{2}} \qquad Formula ( 1 )$$

A represents a target music semantic feature vector, and B represents another target music semantic feature vector. dist(A, B) represents calculating a spatial similarity between A and B, ∥A∥₂ represents a modulus length of A, and ∥B∥₂ represents a modulus length of B.

Then, screening is performed according to a preset spatial similarity threshold, so that classification and aggregation can be performed on all target music semantic feature vectors according to similarities, so that different music segments are classified into different categories to obtain each same-type music segment set.

In the foregoing embodiment, classification and aggregation are performed by calculating the spatial similarity, so that dependence on a cluster core quantity setting in clustering is avoided, thereby improving efficiency and accuracy of the obtained same-type music segment set.

In an embodiment, step 204 of separately extracting time domain features from the multiple sub-audios, the time domain features including an intermediate time domain feature and a target time domain feature includes the following steps:
separately performing a time domain convolution operation on the multiple sub-audios to obtain at least two intermediate convolution features corresponding to the multiple sub-audios and a final convolution feature; performing frequency domain dimension transform on the at least two intermediate convolution features to obtain at least two intermediate time domain features corresponding to the multiple sub-audios; and performing frequency domain dimension transform on the final convolution feature to obtain target time domain features corresponding to the multiple sub-audios.

The time domain convolution operation refers to a convolution operation used for learning of audio time domain information. The final convolution feature refers to a convolution feature obtained by the last convolution operation. The intermediate convolution feature refers to a convolution feature obtained by another convolution operation than the last convolution operation. For example, when there are two time domain convolution operations, the first time domain convolution operation obtains an intermediate convolution feature, and then the second convolution operation is performed by using the intermediate convolution feature to obtain a final convolution feature. When there are more than two time domain convolution operations, the first time domain convolution operation obtains an intermediate convolution feature, and then the second convolution operation is performed by using the intermediate convolution feature to obtain a second intermediate convolution feature. Then, a next convolution operation is continued on the second intermediate convolution feature until the final convolution operation is performed to obtain a final convolution feature, and a convolution feature obtained by another convolution operation other than the last convolution operation is used as an intermediate convolution feature. Frequency domain dimension transform refers to a process of transforming a time domain feature into a same dimension as a frequency domain feature.

Specifically, the server separately performs a time domain convolution operation on each sub-audio to obtain at least two intermediate convolution features corresponding to each sub-audio and a final convolution feature obtained by the last convolution operation. Then, frequency domain dimension transform is performed on each intermediate convolution feature to obtain at least two intermediate time domain features corresponding to each sub-audio, and at the same time, frequency domain dimension transform is performed on the final convolution feature to obtain a target time domain feature corresponding to each sub-audio.

In a specific embodiment, the server sequentially inputs each sub-audio into a large quantity of one-dimensional convolution layers to perform convolution operations, where different convolution layers have different convolution parameters to obtain an outputted one-dimensional convolution feature sequence; then transforms the one-dimensional convolution feature sequence into a two-dimensional wavegram to obtain a target time domain feature; and obtains a one-dimensional intermediate convolution feature outputted by each convolution layer, and transforms the one-dimensional intermediate convolution feature into a two-dimensional wavegram to obtain each intermediate time domain feature. For example, the one-dimensional convolution feature sequence is [1, 2, 3, 4, 5, 6, 7, 8, 9], and then is transformed into a two-dimensional wavegram. If a dimension of a frequency domain feature is a two-dimensional wavegram of 3×3, a target time domain feature obtained by means of transform is [[1, 2, 3], [4, 5, 6], [7, 8, 9]], that is, a two-dimensional wavegram of 3×3, and the transform process may be represented as transform from time domain to frequency domain. The time domain feature of the audio signal is directly learned by using a large quantity of convolution layers in the time domain signal, including information such as audio loudness and sampling point amplitude. Then, the generated one-dimensional sequence is resized (transformed) into a two-dimensional wavegram, so that a time domain feature can be concatenated with a frequency domain feature.

In an embodiment, step 206 of separately extracting frequency domain features from the multiple sub-audios, the frequency domain features including an intermediate frequency domain feature and a target frequency domain feature includes:
extracting basic audio features corresponding to the multiple sub-audios; and perform a frequency domain convolution operation on the basic audio features corresponding to the multiple sub-audios to obtain at least two intermediate frequency domain features and target frequency domain features corresponding to the multiple sub-audios.

The frequency domain convolution operation refers to a convolution operation used for learning of audio frequency domain information.

Specifically, the server extracts a basic audio feature corresponding to each sub-audio, and then performs multiple times of frequency domain convolution operations on each basic audio feature. A convolution operation may be performed by using a convolutional neural network, or all basic audio features may be concatenated into one feature, and the feature is subjected to multiple times of frequency-domain convolution operations, that is, all basic audio features may be concatenated to obtain a concatenated feature, and then the concatenated feature is subjected to a frequency domain convolution operation, where the concatenated feature may be subjected to a convolution operation by using a trained convolutional neural network to obtain an outputted intermediate frequency domain feature, and then the intermediate frequency domain feature is subjected to a convolution operation by using a trained convolutional neural network to obtain an outputted second intermediate frequency domain feature, and a convolution operation continues to be performed to obtain an intermediate frequency domain feature outputted by each convolution operation, until a final convolution operation is performed by using a trained convolutional neural network to obtain an outputted target frequency domain feature. A quantity of frequency domain convolution operations is the same as a quantity of time domain convolution operations, that is, each time domain convolution feature has a corresponding frequency domain convolution feature. The last frequency domain convolution operation obtains the target frequency domain feature, and another frequency domain convolution operation obtains an intermediate frequency domain feature, to finally obtain at least two intermediate frequency domain features and the target frequency domain feature that are corresponding to each sub-audio.

In a specific embodiment, the server obtains each sub-audio, and then calculates a frequency domain spectrum corresponding to each sub-audio, which may be a log-mel spectrum, and uses a mel frequency. Then, the frequency domain spectrum is inputted into multiple two-dimensional convolution layers, and a frequency domain feature map with a dimension same as a time domain feature is outputted, where the frequency domain feature includes multiple intermediate frequency domain features and a target frequency domain feature, that is, each two-dimensional convolution layer outputs one frequency domain feature, the last two-dimensional convolution layer outputs a target frequency domain feature, and another two-dimensional convolution layer outputs an intermediate frequency domain feature.

In the foregoing embodiment, the basic audio feature corresponding to each sub-audio is extracted. Then, a frequency domain convolution operation is performed on the basic audio feature to obtain at least two intermediate frequency domain features and a target frequency domain feature that are corresponding to each sub-audio, thereby improving accuracy of the obtained frequency domain feature.

In an embodiment, there are at least two intermediate time domain features, there are at least two intermediate frequency domain features, and a quantity of intermediate time domain features is consistent with a quantity of intermediate frequency domain features.

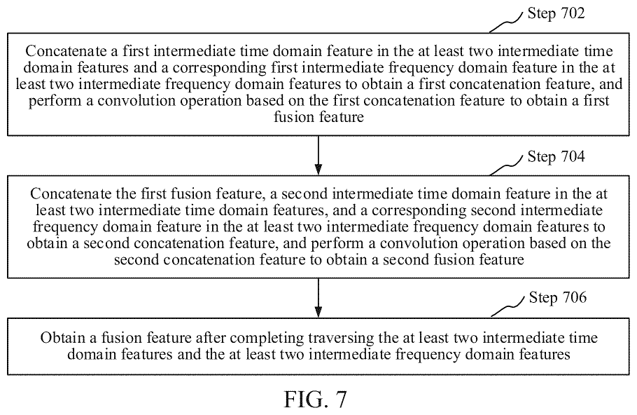

As shown in FIG. 7, step 208 of performing feature fusion on intermediate time domain features corresponding to the multiple sub-audios and intermediate frequency domain features corresponding to the multiple sub-audios, to obtain fusion features corresponding to the multiple sub-audios includes:

Step 702: Concatenate a first intermediate time domain feature in the at least two intermediate time domain features and a corresponding first intermediate frequency domain feature in the at least two intermediate frequency domain features to obtain a first concatenation feature, and perform a convolution operation based on the first concatenation feature to obtain a first fusion feature.

The concatenation feature refers to a feature obtained by concatenating features according to a channel or feature dimension. The fusion feature refers to a feature obtained after feature fusion is performed. Fusion may be performing a convolution operation after features are concatenated.

Specifically, there are at least two intermediate time domain features, there are at least two intermediate frequency domain features, and each intermediate time domain feature has a corresponding intermediate frequency domain feature, that is, a quantity of intermediate time domain features is consistent with a quantity of intermediate frequency domain features. In a specific embodiment, the server performs feature extraction by using a convolutional layer of a neural network, that is, a quantity of convolutional layers for performing frequency domain feature extraction is the same as a quantity of convolutional layers for performing time domain feature extraction, that is, a frequency domain feature outputted by a convolutional layer for performing the first frequency domain feature extraction is corresponding to a time domain feature outputted by a convolutional layer for performing the first time domain feature extraction, a frequency domain feature outputted by a convolutional layer for performing the second frequency domain feature extraction is corresponding to a time domain feature outputted by a convolutional layer for performing the second time domain feature extraction, until a frequency domain feature outputted by a convolutional layer for performing the last frequency domain feature extraction is corresponding to a time domain feature outputted by a convolutional layer for performing the last time domain feature extraction.

The server obtains the first intermediate time domain feature and the corresponding first intermediate frequency domain feature, and both the first intermediate time domain feature and the corresponding first intermediate frequency domain feature are obtained by using the convolution operation of the first convolution layer. Then, the first intermediate time domain feature and the corresponding first intermediate frequency domain feature are concatenated in a channel or feature dimension to obtain the first concatenation feature. Then a convolution operation is performed on the first concatenation feature by using the convolution parameter, to obtain the outputted first fusion feature.

Step 704: Concatenate the first fusion feature, a second intermediate time domain feature in the at least two intermediate time domain features, and a corresponding second intermediate frequency domain feature in the at least two intermediate frequency domain features to obtain a second concatenation feature, and perform a convolution operation based on the second concatenation feature to obtain a second fusion feature.

Specifically, when performing next concatenation of the intermediate time domain feature and the intermediate frequency domain feature, the server concatenates the first fusion feature obtained last time to obtain a second concatenation feature; and then performs a convolution operation on the second concatenation feature by using the convolution parameter to obtain a second fusion feature.

Step 706: Obtain a target interaction feature after completing traversing the at least two intermediate time domain features and the at least two intermediate frequency domain features.

Specifically, the server sequentially performs feature interaction on each intermediate time domain feature and a corresponding intermediate frequency domain feature, that is, obtains a previous interaction feature, concatenates the previous interaction feature with a current intermediate time domain feature and intermediate frequency domain feature, and then performs a convolution operation on the concatenated feature by using a convolution parameter of a trained convolutional neural network, to obtain a current fusion feature. Until feature fusion is performed for the last time, a previous fusion feature is concatenated with the last intermediate time domain feature and the last intermediate frequency domain feature to obtain a final concatenation feature, and a convolution operation is performed on the last concatenation feature by using a convolution parameter to obtain an outputted final fusion feature.

In the foregoing embodiment, feature fusion is performed on the intermediate time domain feature and the corresponding intermediate frequency domain feature, so that time domain and frequency domain keep complementary information. In addition, a higher-layer network can perceive bottom-layer network information, so that an obtained fusion feature can be more accurate.

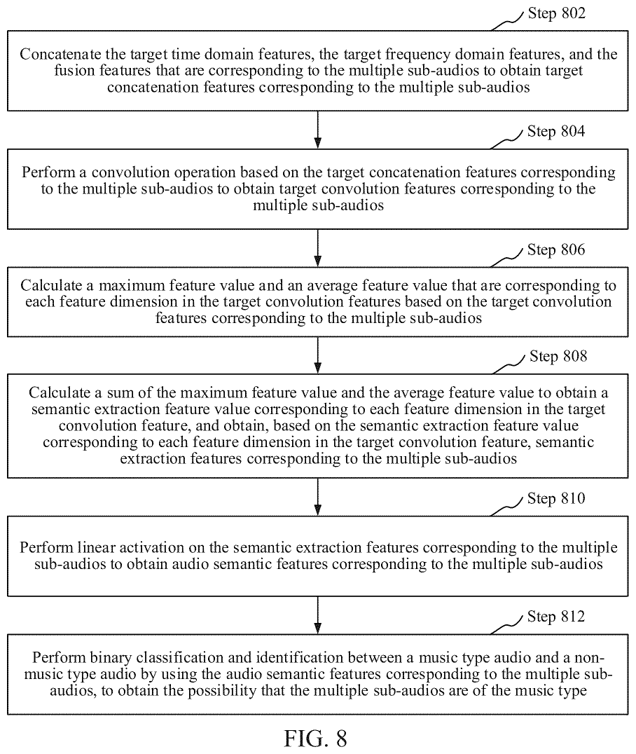

In an embodiment, as shown in FIG. 8, step 210 of performing semantic feature extraction based on target time domain features, target frequency domain features, and the fusion features that are corresponding to the multiple sub-audios, to obtain audio semantic features corresponding to the multiple sub-audios, and performing music type classification and identification based on the audio semantic features, to obtain a possibility that the multiple sub-audios are of a music type includes:

Step 802: Concatenate the target time domain features, the target frequency domain features, and the fusion features that are corresponding to the multiple sub-audios to obtain target concatenation features corresponding to the multiple sub-audios.

Step 804: Perform a convolution operation based on the target concatenation features corresponding to the multiple sub-audios to obtain target convolution features corresponding to the multiple sub-audios.

The target concatenation feature refers to a feature obtained after the target time domain feature, the target frequency domain feature, and the target interaction feature are concatenated. The target convolution feature refers to a feature obtained by performing a convolution operation on the target concatenation feature.

Specifically, after successively concatenating the target time domain feature, the target frequency domain feature, and the target interaction feature that are corresponding to each sub-audio according to the channel or feature dimension, the server obtains the target concatenation feature corresponding to each sub-audio; and inputs the target concatenation feature corresponding to each sub-audio into a convolutional neural network, that is, a convolutional layer, and uses a convolutional parameter to perform a convolution operation, so as to output the target convolution feature corresponding to each sub-audio.

Step 806: Calculate a maximum feature value and an average feature value that are corresponding to each feature dimension in the target convolution features based on the target convolution features corresponding to the multiple sub-audios.

Step 808: Calculate a sum of the maximum feature value and the average feature value to obtain a semantic extraction feature value corresponding to each feature dimension in the target convolution feature, and obtain, based on the semantic extraction feature value corresponding to each feature dimension in the target convolution feature, semantic extraction features corresponding to the multiple sub-audios.

The maximum feature value refers to a maximum feature value of all feature values corresponding to the feature dimension. The average feature value refers to an average of all the feature values corresponding to the feature dimension. The semantic extraction feature value refers to an extracted feature value used for representing audio semantic information.

Specifically, the server successively calculates a semantic extraction feature corresponding to each sub-audio; obtains a target convolution feature corresponding to a sub-audio that is currently to be calculated, and then determines a maximum feature value and an average feature value that are corresponding to each feature dimension in the target convolution feature, that is, calculates an average feature value and a maximum feature value of all feature values corresponding to each feature dimension; and then calculates a sum of the maximum feature value and an average feature value, to obtain a semantic extraction feature value corresponding to each feature dimension in the target convolution feature, and uses the semantic extraction feature value corresponding to each feature dimension as a semantic extraction feature corresponding to a current sub-audio. In a specific embodiment, the target convolution feature may be [[1, 2, 3], [3, 4, 5]]. Then, a maximum value of each feature dimension is calculated, that is, values corresponding to the first feature dimension are 1 and 3, and the maximum value is 3. Values corresponding to the second feature dimension are 2 and 4, and the maximum value is 4. Values corresponding to the third characteristic dimension are 3 and 5, and the maximum value is 5, so as to obtain maximum feature values [3, 4, 5]. Then, an average value of each feature dimension is calculated, that is, an average value of the values 1 and 3 corresponding to the first feature dimension is calculated as 2, an average value of the values 2 and 4 corresponding to the second feature dimension is calculated as 3, and an average value of the values 3 and 5 corresponding to the third feature dimension is calculated as 4, so as to obtain average feature values [2, 3, 4]. Finally, a maximum value and an average value of each feature dimension are added, that is, the sum of 3 and 2 of the first feature dimension is calculated as 5, the sum of 4 and 3 of the second feature dimension is calculated as 7, and the sum of 5 and 4 of the third feature dimension is calculated as 9, so as to obtain semantic extraction features [5, 7, 9].

Step 810: Perform linear activation on the semantic extraction features corresponding to the multiple sub-audios to obtain audio semantic features corresponding to the multiple sub-audios.

Step 812: Perform binary classification and identification between a music type audio and a non-music type audio by using the audio semantic features corresponding to the multiple sub-audios, to obtain the possibility that the multiple sub-audios are of the music type.

Specifically, the server sequentially performs linear activation on the semantic extraction feature corresponding to each sub-audio by using a linear activation function, to obtain an audio semantic feature corresponding to each sub-audio, and then uses the audio semantic feature to perform binary classification and identification between audio of a music type and audio of a non-music type by using a classification function, to obtain a possibility that each sub-audio corresponds to a music type. For example, a linear rectification function (RELU) linear activation function may be used for performing linear activation, and then softmax (softmax is used for mapping an output from a neuron to the (0,1) interval during classification) is used for performing binary classification and identification between a music type audio and a non-music type audio to obtain a probability that an outputted sub-audio is of the music type, so as to obtain a possibility that the sub-audio is of the music type. Alternatively, the server may calculate a probability that the sub-audio is of the non-music type, that is, a possibility that the sub-audio is of the non-music type, and then calculates the possibility that the sub-audio is of the music type according to the possibility of being the non-music type, that is, the sum of the possibility of being the non-music type and the possibility of being the music type is 100%.

In the foregoing embodiment, the maximum feature value and the average feature value are calculated, and the maximum feature value and the average feature value are used for obtaining the semantic extraction feature. Because the maximum feature value can represent most representative information, the average feature value can maintain information of an entire layer, so that accuracy of an extracted audio semantic feature can be improved. Then, the audio semantic feature is used for binary classification and identification, thereby improving accuracy of the obtained music possibility.

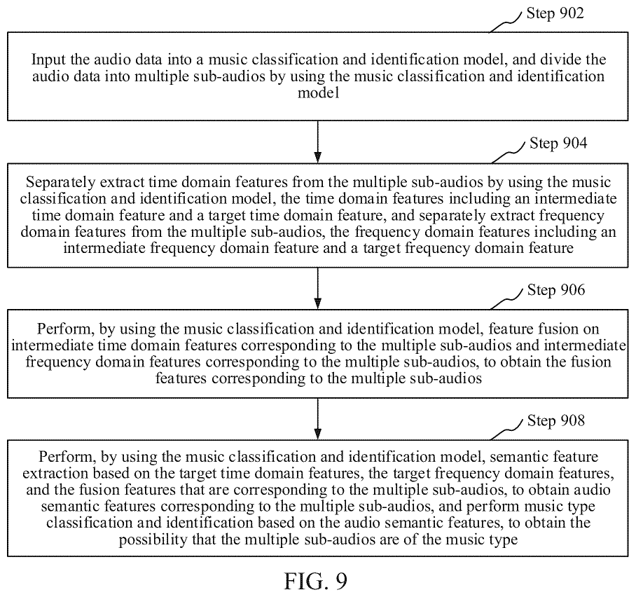

In an embodiment, as shown in FIG. 9, the audio data processing method further includes:

Step 902: Input the audio data into a music classification and identification model, and divide the audio data into multiple sub-audios by using the music classification and identification model.

Step 904: Separately extract time domain features from the multiple sub-audios by using the music classification and identification model, the time domain features including an intermediate time domain feature and a target time domain feature, and separately extract frequency domain features from the multiple sub-audios, the frequency domain features including an intermediate frequency domain feature and a target frequency domain feature.

Step 906: Perform, by using the music classification and identification model, feature fusion on intermediate time domain features corresponding to the multiple sub-audios and intermediate frequency domain features corresponding to the multiple sub-audios, to obtain the fusion features corresponding to the multiple sub-audios.

Step 908: Perform, by using the music classification and identification model, semantic feature extraction based on the target time domain features, the target frequency domain features, and the fusion features that are corresponding to the multiple sub-audios, to obtain audio semantic features corresponding to the multiple sub-audios, and perform music type classification and identification based on the audio semantic features, to obtain the possibility that the multiple sub-audios are of the music type.

The music classification and identification model is used for performing binary classification and identification on the audio data to determine whether the audio data is music or non-music. The music classification and identification model is obtained by pre-training by using a cross-entropy loss function, the music classification and identification model is established by using a neural network, and the neural network may be a convolutional neural network, a fully connected neural network, a recurrent neural network, or the like. The music classification and identification model may be trained by using training audio data and a corresponding training label.

Specifically, the server pre-trains the music classification and identification model, and then deploys and uses the music classification and identification model. When needing to be used, the music classification and identification model is invoked to perform music classification and identification on the audio data. That is, the audio data is obtained, and the audio data is inputted into the music classification and identification model. The music classification and identification model is a dual-branch neural network. That is, the music classification and identification model simultaneously extracts, by using the dual branches, a target frequency domain feature and a target time domain feature that are corresponding to the audio data, and performs feature fusion, that is, performs feature fusion on the extracted intermediate frequency domain feature and intermediate time domain feature so as to obtain a fusion feature, then further extracts a semantic feature according to the obtained target frequency domain feature, the obtained target time domain feature, and the obtained fusion feature, and finally performs music classification and identification according to the obtained semantic feature.

In the foregoing embodiment, music classification and identification is performed by using the music classification and identification model, to obtain possibilities that multiple sub-audios are of the music type, thereby improving efficiency of music classification and identification.

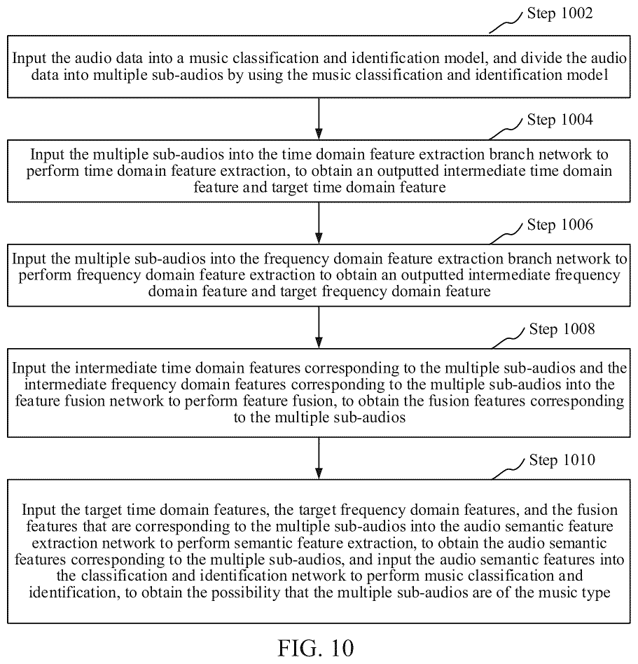

In an embodiment, the music classification and identification model includes a time domain feature extraction branch network, a frequency domain feature extraction branch network, a feature fusion network, an audio semantic feature extraction network, and a classification and identification network. As shown in FIG. 10, the audio data processing method further includes:

Step 1002: Input the audio data into a music classification and identification model, and divide the audio data into multiple sub-audios by using the music classification and identification model.

Step 1004: Input the multiple sub-audios into the time domain feature extraction branch network to perform time domain feature extraction, to obtain an outputted intermediate time domain feature and target time domain feature.

Step 1006: Input the multiple sub-audios into the frequency domain feature extraction branch network to perform frequency domain feature extraction to obtain an outputted intermediate frequency domain feature and target frequency domain feature.

Step 1008: Input the intermediate time domain features corresponding to the multiple sub-audios and the intermediate frequency domain features corresponding to the multiple sub-audios into the feature fusion network to perform feature fusion, to obtain the fusion features corresponding to the multiple sub-audios.

Step 1010: Input the target time domain features, the target frequency domain features, and the fusion features that are corresponding to the multiple sub-audios into the audio semantic feature extraction network to perform semantic feature extraction, to obtain the audio semantic features corresponding to the multiple sub-audios, and input the audio semantic features into the classification and identification network to perform music classification and identification, to obtain the possibility that the multiple sub-audios are of the music type.

The time domain feature extraction branch network is a neural network used for extracting a time domain feature of an audio. The frequency domain feature extraction branch network is a neural network used for extracting a frequency domain feature of an audio. The feature fusion network refers to a neural network that performs feature fusion on an intermediate frequency domain feature and an intermediate time domain feature. The audio semantic feature extraction network is a neural network used for extracting a semantic feature of an audio. The classification and identification network is a neural network used for performing binary classification and identification on an audio of the music type and an audio of the non-music type.

Specifically, the server inputs each sub-audio into the time domain feature extraction branch network to perform time domain feature extraction, that is, uses a convolution layer in the time domain feature extraction branch network to output a time domain feature, where the target time domain feature is outputted by using the last convolution layer, and the intermediate time domain feature is outputted by using another convolution layer. In addition, each sub-audio is inputted to the frequency domain feature extraction branch network to perform frequency domain feature extraction, that is, a convolution layer in the frequency domain feature extraction branch network is used for outputting a frequency domain feature, where the target frequency domain feature is outputted by using the last convolution layer, and the intermediate frequency domain feature is outputted by using another convolution layer. A quantity of convolution layers in the time domain feature extraction branch network and a quantity of convolution layers in the frequency domain feature extraction branch network are the same. The feature fusion network performs feature fusion on the intermediate time domain feature and the corresponding intermediate frequency domain feature, where the intermediate time domain feature and the corresponding intermediate frequency domain feature are features outputted at the same level of convolution layer, so as to obtain a fusion feature, then an audio semantic feature is extracted by using the audio semantic feature extraction network, and then music classification and identification are performed by using the classification and identification network, to obtain a music possibility corresponding to each sub-audio.

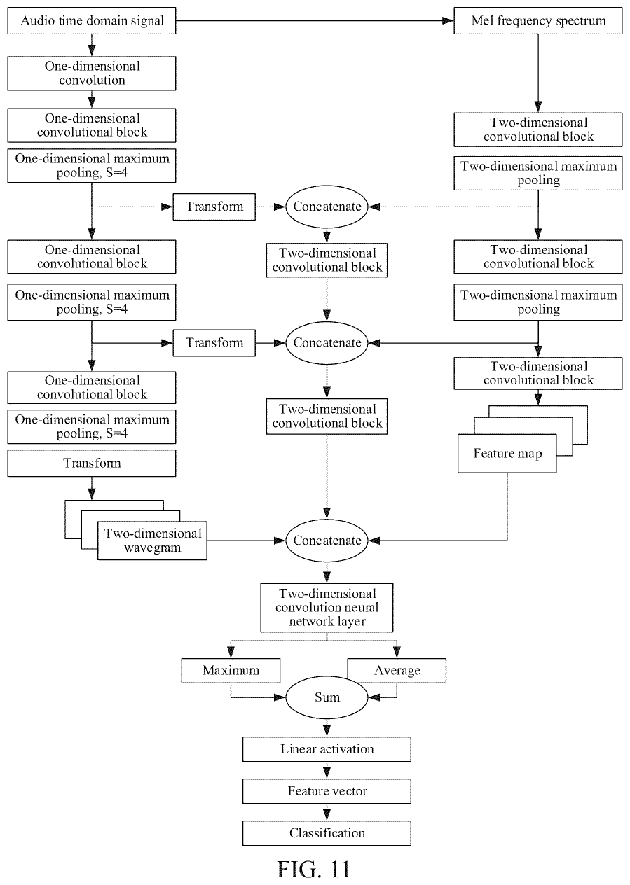

In a specific embodiment, as shown in FIG. 11, a schematic diagram of a network architecture of a music classification and identification model is provided. The music classification and identification model uses a dual-flow network architecture. Specifically, the music classification and identification model classifies two branches to obtain audio data, that is, an original audio sampling point sequence, and calculates a frequency domain spectrum corresponding to the original audio sampling point sequence, which may be a mel spectrum. The original audio sampling point sequence is then inputted into the left time domain convolutional neural network branch, and the mel spectrum is inputted into the right frequency domain convolutional neural network branch. A large quantity of one-dimensional convolution layers are used in the left time domain convolution neural network branch. After the large quantity of one-dimensional convolution layers, a one-dimensional convolution operation is performed in each one-dimensional convolution layer by using a one-dimensional convolution block, and one-dimensional maximum pooling with a step of 4 (S=4) is performed to obtain a finally outputted one-dimensional convolution feature, and then the finally outputted one-dimensional convolution feature is transformed into a two-dimensional wavegram to obtain a target time domain feature, where the target time domain feature is a two-dimensional wavegram. A reshape function may be used for transform. The reshape function is a function that transforms a specified matrix into a specific dimension matrix. A large quantity of two-dimensional convolutional layers are used in the right frequency domain convolutional neural network branch. After the large quantity of two-dimensional convolutional layers, a two-dimensional convolution operation is performed by using a two-dimensional convolutional block in each two-dimensional convolutional layer, to obtain a finally outputted target frequency domain feature, where the target frequency domain feature is a feature map with the same dimension as the target time domain feature. In addition, information exchange for multiple times exists in the middle position of the left time domain convolution neural network branch and the right frequency domain convolution neural network branch. That is, the intermediate convolution feature outputted by the one-dimensional convolution layer in the left time domain convolution neural network branch is transformed by using the reshape function to obtain the intermediate time domain feature, and then concatenation is performed with the intermediate frequency domain feature outputted by the two-dimensional convolution layer in the right frequency domain convolution neural network branch to obtain a concatenation feature, and then the concatenation feature is inputted into a two-dimensional convolution block to perform two-dimensional convolution, to obtain an outputted current fusion feature. Then, as an input at the next concatenation, the current fusion feature is concatenated with the intermediate time domain feature and the intermediate frequency domain feature at the next concatenation, and information is constantly exchanged until the fusion feature is finally obtained. Then, the fusion feature, the target frequency domain feature, and the target time domain feature are superposed together to form a group of two-dimensional frequency domain feature maps. The group of two-dimensional frequency domain feature maps is inputted into the two-dimensional convolutional neural network layer for a convolution operation, then an average value and a maximum value are calculated according to each feature dimension, and then a sum of the average value and the maximum value is calculated, to obtain a feature that includes most representative information and information of an entire layer, thereby improving accuracy of the obtained feature. Then the feature is linearly activated by using one RELU network layer, to obtain a final extracted audio semantic feature vector, and then audio of a music type and audio of a non-music type are identified by using the audio semantic feature vector by using a softmax classification and identification layer, to obtain an outputted music type posterior probability curve, where the music type posterior probability curve represents a probability indicating whether each audio frame is corresponding to the music type. According to the music type posterior probability curve, positioning and cutting can be performed on each music segment, and a time start point and cutoff point of each music segment can be obtained. Corresponding extraction of an audio semantic feature vector sequence subset is performed according to the time start point and cutoff point of each music segment, to obtain a music semantic feature corresponding to the music segment, thereby improving accuracy of the obtained music semantic feature.

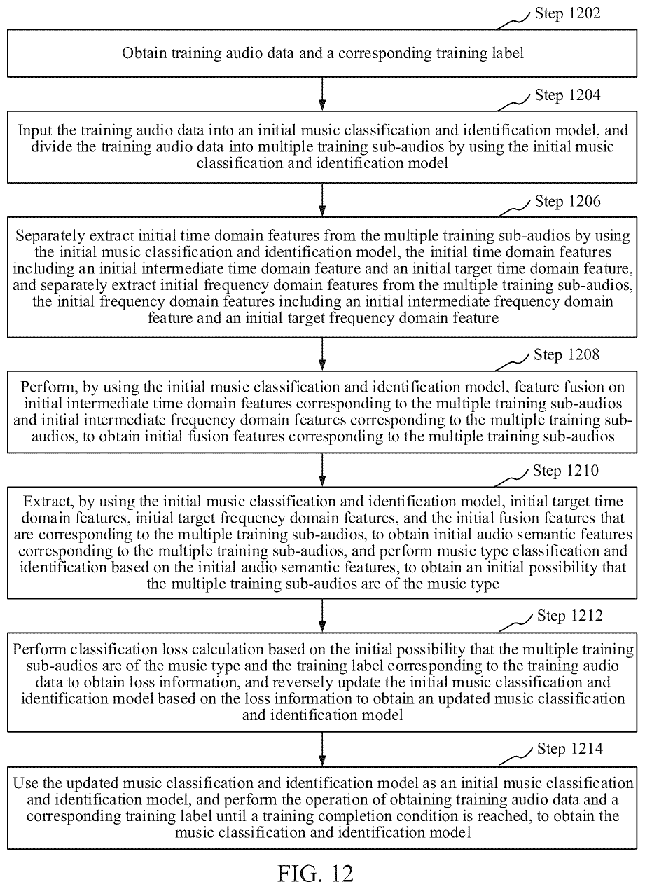

In an embodiment, as shown in FIG. 12, training steps of the music classification and identification model include:

Step 1202: Obtain training audio data and a corresponding training label.

The training audio data is audio data used during training. The training label refers to a label that is corresponding to the training audio data and that indicates whether the training audio data is music, and includes a music label and a non-music label. In the training audio data, each audio frame may have a corresponding training label.

Specifically, the server may directly obtain the training audio data and the training label from a database. The server may alternatively obtain the training audio data and the corresponding training label from a service provider that provides a data service. The server may alternatively obtain the training audio data uploaded by a terminal and the corresponding training label.

Step 1204: Input the training audio data into an initial music classification and identification model, and divide the training audio data into multiple training sub-audios by using the initial music classification and identification model.

Step 1206: Separately extract time domain features from the multiple training sub-audios by using an initial music classification and identification model, the initial time domain features including an initial intermediate time domain feature and an initial target time domain feature; and separately extract frequency domain features from the multiple training sub-audios, the initial frequency domain features including an initial intermediate frequency domain feature and an initial target frequency domain feature.

Step 1208: Perform, by using the initial music classification and identification model, feature fusion on initial intermediate time domain features corresponding to the multiple training sub-audios and initial intermediate frequency domain features corresponding to the multiple training sub-audios, to obtain initial fusion features corresponding to the multiple training sub-audios.

Step 1210: Extract, by using the initial music classification and identification model, initial target time domain features, initial target frequency domain features, and the initial fusion features that are corresponding to the multiple training sub-audios, to obtain initial audio semantic features corresponding to the multiple training sub-audios, and perform music type classification and identification based on the initial audio semantic features, to obtain an initial possibility that the multiple training sub-audios are of the music type.

The initial music classification and identification model refers to a music classification and identification model in which a model parameter is initialized. The training sub-audio refers to a sub-audio obtained by means of division during training. The initial time domain feature refers to a time domain feature extracted by using an initialized model parameter. The initial frequency domain feature refers to a frequency domain feature extracted by using an initialized model parameter. The initial possibility refers to a possibility of predicting the music type by using an initialized model parameter.

Specifically, the server establishes an initial music classification and identification model by using a neural network, and then performs initial music classification and identification prediction on the training audio data by using the initial music classification and identification model, to obtain an initial music possibility corresponding to each outputted training sub-audio. A process in which the initial music classification and identification model performs music classification and identification prediction is consistent with a process in which a trained music classification and identification model performs identification prediction.

Step 1212: Perform classification loss calculation based on the initial possibility that the multiple training sub-audios are of the music type and the training label corresponding to the training audio data to obtain loss information, and reversely update the initial music classification and identification model based on the loss information to obtain an updated music classification and identification model.

Step 1214: Use the updated music classification and identification model as an initial music classification and identification model, and perform the operation of obtaining training audio data and a corresponding training label until a training completion condition is reached, to obtain the music classification and identification model.

The loss information is used for representing a training error of the model, and refers to an error between an initial possibility and a corresponding training label. The updated music classification and identification model refers to a model obtained after a parameter of the initial music classification and identification model is updated. The training completion condition refers to a condition at the end of training the initial music classification and identification model, including that a quantity of model iterations exceeds a maximum quantity of iterations, a model parameter does not change, model loss information exceeds a preset threshold, and the like.

Specifically, the server determines and calculates the loss information during model training, and then determines whether the training completion condition is met. For example, the loss information is compared with a preset loss threshold. When the preset loss threshold is reached, it indicates that the training is completed. When the preset loss threshold is not reached, it indicates that the training is not completed. In this case, cyclic iteration continues until the training completion condition is reached, and the initial music classification and identification model that meets the training completion condition is used as a music classification and identification model that is finally trained.

In the foregoing embodiment, an initial music classification and identification model is trained by using training audio data and a corresponding training label, so as to obtain a music classification and identification model, and the music classification and identification model is separately established and trained, thereby reducing a training error, so that accuracy of the obtained music classification and identification model can be improved by training, and further, accuracy of audio data processing can be improved.

In a specific embodiment, the server may establish an initial audio data processing model, and then obtain training data to train the initial audio data processing model to obtain an audio data processing model, and perform audio data processing by using the audio data processing model. Specifically, audio data is divided by using an audio data processing model to obtain multiple sub-audios, time domain features including an intermediate time domain feature and a target time domain feature are separately extracted from the multiple sub-audios, and frequency domain features including an intermediate frequency domain feature and a target frequency domain feature are separately extracted from the multiple sub-audios. Feature fusion is performed based on the intermediate time domain features and the intermediate frequency domain features that are corresponding to the multiple sub-audios, to obtain fusion features corresponding to the multiple sub-audios. Semantic feature extraction is performed based on the target time domain features, the target frequency domain features, and the fusion features that are corresponding to the multiple sub-audios, to obtain audio semantic features corresponding to the multiple sub-audios. Music classification and identification is performed based on the audio semantic features, to obtain music possibilities corresponding to the multiple sub-audios. Each music segment is determined from the audio data based on the music possibilities, a music semantic feature corresponding to each music segment is determined based on the audio semantic feature, and a music segment classification and identification is performed based on the music semantic feature corresponding to each music segment, to obtain a same-type music segment set. Training audio data and a corresponding training capacity music segment set may be used in advance to train an initial audio data processing model. When training is completed, an audio data processing model is obtained, and then the audio data processing model is deployed and used for improving efficiency and accuracy of audio data processing.

In an embodiment, after step 214 of performing music segment clustering based on the music semantic feature corresponding to each music segment, to obtain a same-type music segment set, the method further includes the following steps:
obtaining video segments corresponding to the music segments in the same-type music segment set, to obtain a video segment set; and concatenating the same-type music segment set and the video segment set to obtain a same-type audio-video set.

The video segment set includes each video segment, and each music segment in the same-type music segment set may have a corresponding video segment, that is, there is a corresponding music audio and video at the same moment. A same-type audio-video set includes various audio-video segments of the same type.

Specifically, the server may obtain video data that is corresponding to audio data and that has the same time sequence, that is, the audio data may be obtained by performing audio-video splitting from an original audio-video, and then the video data is obtained from the original audio-video as the video data corresponding to the audio data; then, determines, according to each music segment in a same-type music segment set, a video segment corresponding to the music segment from the video data that has the same time sequence; and finally, concatenates the same-type music segment set and a video segment set, where an original audio-video segment is obtained according to the music segment in the same-type music segment set and the corresponding video segment, and then all original audio-video segments are concatenated to obtain a same-type audio-video collection. Then, the same-type audio-video collection may be played on a terminal, that is, the concatenated same-type original audio-video segment is displayed on the terminal.

In the foregoing embodiment, the same-type music segment set and video segment set may be concatenated to obtain the same-type audio-video set, which can quickly locate and cut the video data, thereby improving efficiency of obtaining the same-type audio-video set.

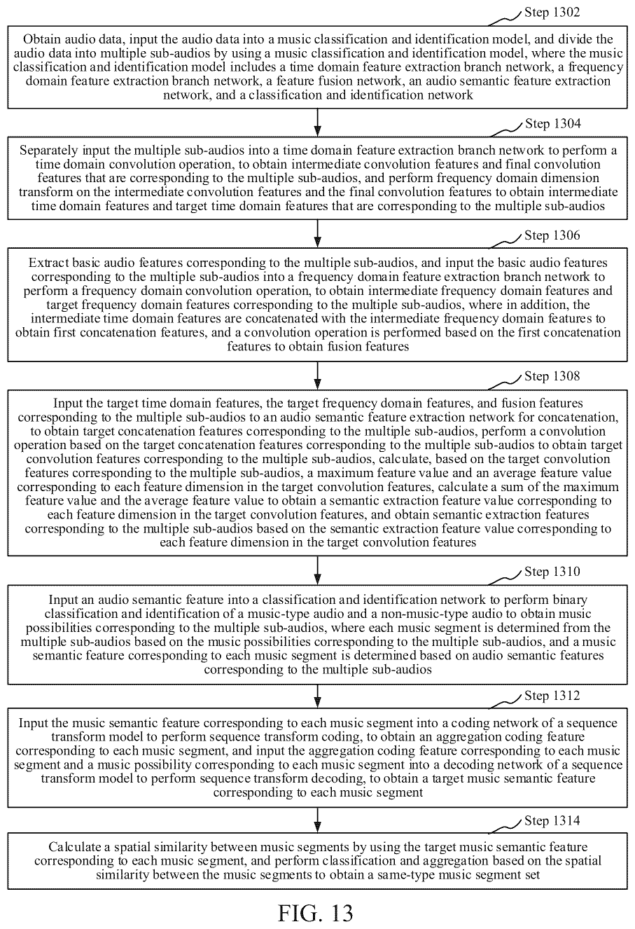

In a specific embodiment, as shown in FIG. 13, an audio data processing method is provided, and is performed by a computer device. The computer device may be a terminal or a server, and specifically includes the following steps:

Step 1302: Obtain audio data, input the audio data into a music classification and identification model, and divide the audio data into multiple sub-audios by using a music classification and identification model, where the music classification and identification model includes a time domain feature extraction branch network, a frequency domain feature extraction branch network, a feature fusion network, an audio semantic feature extraction network, and a classification and identification network.

Step 1304: Separately input the multiple sub-audios into a time domain feature extraction branch network to perform a time domain convolution operation, to obtain intermediate convolution features and final convolution features that are corresponding to the multiple sub-audios, and perform frequency domain dimension transform on the intermediate convolution features and the final convolution features to obtain intermediate time domain features and target time domain features that are corresponding to the multiple sub-audios.

Step 1306: Extract basic audio features corresponding to the multiple sub-audios, and input the basic audio features corresponding to the multiple sub-audios into a frequency domain feature extraction branch network to perform a frequency domain convolution operation, to obtain intermediate frequency domain features and target frequency domain features corresponding to the multiple sub-audios. In addition, the intermediate time domain features are concatenated with the intermediate frequency domain features to obtain first concatenation features, and a convolution operation is performed based on the first concatenation features to obtain fusion features.

Step 1308: Input the target time domain features, the target frequency domain features, and fusion features corresponding to the multiple sub-audios to an audio semantic feature extraction network for concatenation, to obtain target concatenation features corresponding to the multiple sub-audios, perform a convolution operation based on the target concatenation features corresponding to the multiple sub-audios to obtain target convolution features corresponding to the multiple sub-audios, calculate, based on the target convolution features corresponding to the multiple sub-audios, a maximum feature value and an average feature value corresponding to each feature dimension in the target convolution features, calculate a sum of the maximum feature value and the average feature value to obtain a semantic extraction feature value corresponding to each feature dimension in the target convolution features, and obtain semantic extraction features corresponding to the multiple sub-audios based on the semantic extraction feature value corresponding to each feature dimension in the target convolution features.

Step 1310: Input an audio semantic feature into a classification and identification network to perform binary classification and identification of a music-type audio and a non-music-type audio to obtain music possibilities corresponding to the multiple sub-audios. Each music segment is determined from the multiple sub-audios based on the music possibilities corresponding to the multiple sub-audios, and a music semantic feature corresponding to each music segment is determined based on audio semantic features corresponding to the multiple sub-audios.

Step 1312: Input the music semantic feature corresponding to each music segment into a coding network of a sequence transform model to perform sequence transform coding, to obtain an aggregation coding feature corresponding to each music segment, and input the aggregation coding feature corresponding to each music segment and a music possibility corresponding to each music segment into a decoding network of a sequence transform model to perform sequence transform decoding, to obtain a target music semantic feature corresponding to each music segment.

Step 1314: Calculate a spatial similarity between music segments by using the target music semantic feature corresponding to each music segment, and perform classification and aggregation based on the spatial similarity between the music segments to obtain a same-type music segment set.

In the foregoing embodiment, fusion is performed between a time domain feature and a frequency domain feature, so as to obtain a fusion feature, and then semantic feature extraction is performed by using the fusion feature, a target time domain feature, and a target frequency domain feature, thereby improving accuracy of an obtained semantic extraction feature corresponding to a sub-audio; and then music classification and identification are performed based on the semantic extraction feature, so as to obtain a same-type music segment set, thereby improving accuracy of obtained same-type music segments.

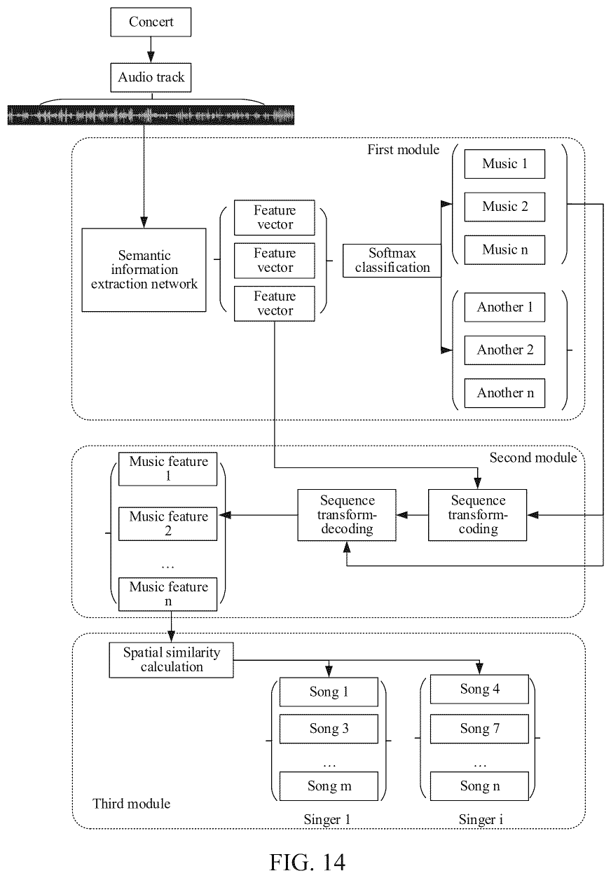

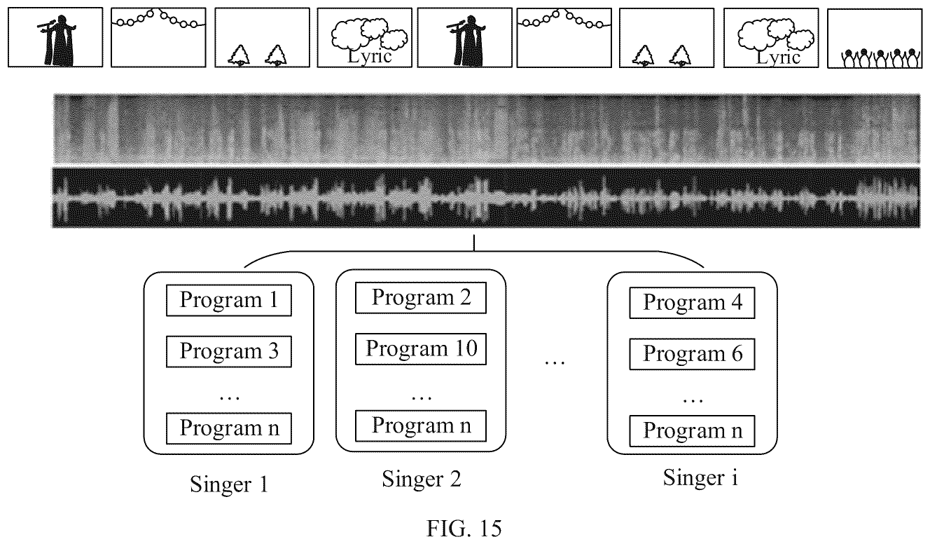

In a specific embodiment, the audio data processing method is applied to a video media platform, which is specifically as follows: FIG. 14 is a schematic diagram of an application scenario of audio data processing. The video media platform obtains a concert audio-video, extracts an audio track from the concert audio-video, and then performs music classification and identification on the audio track by using a first module. That is, the audio track is first divided into frames to obtain each audio frame, and then the audio frame is input into a semantic information extraction network in a music classification and identification model to extract audio semantic information to obtain an audio semantic information feature vector sequence corresponding to each audio frame. Then, classification is performed by using softmax to obtain a music-type audio frame and a non-music-type audio frame. Then, each music segment is determined according to the music-type audio frame, including a music segment 1 and a music segment 2 to a music segment n. Each non-music segment is determined, including another 1 and another 2 to another n. Then, each music segment and a music possibility corresponding to each music segment are inputted into a second module to perform audio semantic information aggregation by using a sequence transform model, where a music semantic feature of each music segment is coded by using a coding network in the sequence transform model, to obtain an outputted coding feature, and then the coding feature and the music possibility corresponding to each music segment are inputted into a decoding network in the sequence transform model for decoding, to obtain a target music semantic feature corresponding to each music segment, including a music feature 1 and a music feature 2 to a music feature n. Then, a target music semantic feature corresponding to each music segment is clustered by using a third module, that is, a spatial similarity between target music semantic features corresponding to each two music segments is calculated, that is, a spatial cosine distance, and all spatial distances are aggregated, so that music segments corresponding to target music semantic features with a relatively high similarity can be aggregated into a music segment set. For example, a music segment set of a singer 1 is obtained, including a song 1 and a song 3 to a song m, and a music segment set of a singer i is obtained, including a song 4 and a song 7 to a song n. Then, an audio-video segment set corresponding to a music segment set of each singer is determined from a concert audio-video, and then audio-video segments in the audio-video segment set of the singer are concatenated to obtain an audio-video collection of the singer, that is, a program collection of each singer in the concert is obtained. Then, the program collection of each singer in the concert may be published on the video media platform, so that a platform user can watch the program collection of each singer in the concert. FIG. 15 is a schematic diagram of an effect of a program collection of each singer in a concert, where all audio-video program segments of a singer 1 and a singer 2 until a singer i are concatenated into audio-video collections. That is, songs of the singer can be categorized and concatenated quickly to generate a corresponding collection, which improves efficiency and accuracy.

It is to be understood that, although the steps are displayed sequentially according to the instructions of the arrows in the flowcharts of the embodiments, these steps are not necessarily performed sequentially according to the sequence instructed by the arrows. Unless otherwise explicitly specified in this specification, execution of the steps is not strictly limited, and the steps may be performed in other sequences. Moreover, at least some of the steps in each embodiment may include multiple steps or multiple stages. The steps or stages are not necessarily performed at the same moment but may be performed at different moments. Execution of the steps or stages is not necessarily sequentially performed, but may be performed alternately with other steps or at least some of steps or stages of other steps.

Based on the same inventive concept, an embodiment of this application further provides an audio data processing apparatus used for implementing the foregoing involved audio data processing method. An implementation solution provided by the apparatus is similar to the implementation solution described in the foregoing method. Therefore, for a specific definition in one or more audio data processing apparatus embodiments provided below, refer to the foregoing definition on the audio data processing method. Details are not described herein again.

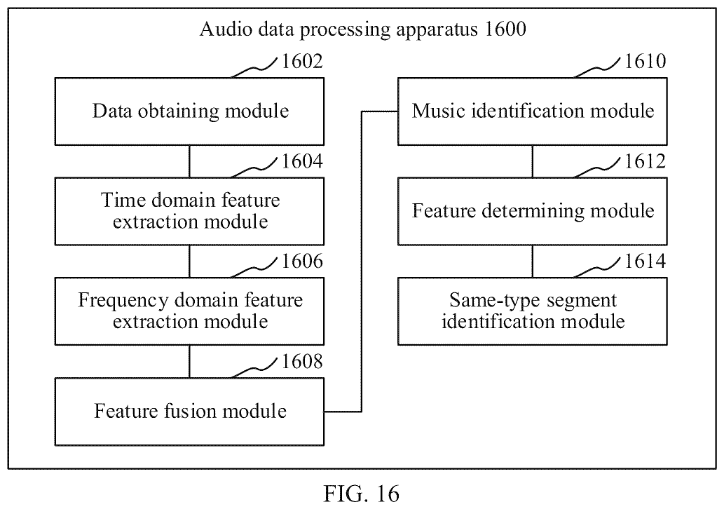

In an embodiment, as shown in FIG. 16, an audio data processing apparatus 1600 is provided, including: a data obtaining module 1602, a time domain feature extraction module 1604, a frequency domain feature extraction module 1606, a feature fusion module 1608, a music identification module 1610, a feature determining module 1612, and a same-type segment identification module 1614.

The data obtaining module 1602 is configured to obtain audio data, and divide the audio data into multiple sub-audios;
the time domain feature extraction module 1604 is configured to separately extract time domain features from the multiple sub-audios, the time domain features including an intermediate time domain feature and a target time domain feature;
the frequency domain feature extraction module 1606 is configured to separately extract frequency domain features from the multiple sub-audios, the frequency domain features including an intermediate frequency domain feature and a target frequency domain feature;
the feature fusion module 1608 is configured to perform feature fusion on intermediate time domain features corresponding to the multiple sub-audios and intermediate frequency domain features corresponding to the multiple sub-audios, to obtain fusion features corresponding to the multiple sub-audios;
the music identification module 1610 is configured to: perform semantic feature extraction based on target time domain features, target frequency domain features, and the fusion features that are corresponding to the multiple sub-audios, to obtain audio semantic features corresponding to the multiple sub-audios, and perform music type classification and identification based on the audio semantic features, to obtain a possibility that the multiple sub-audios are of a music type;
the feature determining module 1612 is configured to: determine each music segment from the multiple sub-audios based on the possibility of being the music type, and determine, based on the audio semantic features corresponding to the multiple sub-audios, a music semantic feature corresponding to the music segment; and
the same-type segment identification module 1614 is configured to perform music segment clustering based on the music semantic feature corresponding to each music segment, to obtain a same-type music segment set.

In an embodiment, the same-type segment identification module 1614 includes:
a coding unit, configured to separately perform sequence transform coding on the music semantic feature corresponding to each music segment to obtain an aggregation coding feature corresponding to each music segment;
a decoding unit, configured to perform sequence transform decoding by using the aggregation coding feature and the possibility that the multiple sub-audios are of the music type, to obtain a target music semantic feature corresponding to each music segment; and
an identification unit, configured to cluster each music segment according to the target music semantic feature corresponding to each music segment, to obtain the same-type music segment set.

In an embodiment, the coding unit is further configured to: extract basic audio features corresponding to the multiple sub-audios, and determine, from the basic audio features corresponding to the multiple sub-audios, a music segment basic feature corresponding to each music segment; separately concatenate the music segment basic feature corresponding to each music segment with the music semantic feature corresponding to each music segment, to obtain a target fusion feature corresponding to each music segment; and input the target fusion feature corresponding to each music segment to a coding network of a sequence transform model for coding, to obtain an outputted target aggregation coding feature corresponding to each music segment.

In an embodiment, the identification unit is further configured to calculate a spatial similarity between the music segments by using the target music semantic feature corresponding to each music segment; and perform classification and aggregation on each music segment according to the spatial similarity between the music segments, to obtain the same-type music segment set.

In an embodiment, the time domain feature extraction module 1604 is further configured to separately perform a time domain convolution operation on the multiple sub-audios to obtain at least two intermediate convolution features corresponding to the multiple sub-audios and a final convolution feature; perform frequency domain dimension transform on the at least two intermediate convolution features to obtain at least two intermediate time domain features corresponding to the multiple sub-audios; and perform frequency domain dimension transform on the final convolution feature to obtain target time domain features corresponding to the multiple sub-audios.

In an embodiment, the frequency domain feature extraction module 1606 is further configured to extract basic audio features corresponding to the multiple sub-audios; and perform a frequency domain convolution operation on the basic audio features corresponding to the multiple sub-audios to obtain at least two intermediate frequency domain features and target frequency domain features corresponding to the multiple sub-audios.

In an embodiment, there are at least two intermediate time domain features, there are at least two intermediate frequency domain features, and a quantity of intermediate time domain features is consistent with a quantity of intermediate frequency domain features. The feature fusion module 1608 is further configured to: concatenate a first intermediate time domain feature in the at least two intermediate time domain features and a corresponding first intermediate frequency domain feature in the at least two intermediate frequency domain features to obtain a first concatenation feature, and perform a convolution operation based on the first concatenation feature to obtain a first fusion feature; concatenate the first fusion feature, a second intermediate time domain feature in the at least two intermediate time domain features, and a corresponding second intermediate frequency domain feature in the at least two intermediate frequency domain features to obtain a second concatenation feature, and perform a convolution operation based on the second concatenation feature to obtain a second fusion feature; and obtain a fusion feature after completing traversing the at least two intermediate time domain features and the at least two intermediate frequency domain features.

In an embodiment, the music identification module 1610 is further configured to: concatenate the target time domain features, the target frequency domain features, and the fusion features that are corresponding to the multiple sub-audios to obtain target concatenation features corresponding to the multiple sub-audios; perform a convolution operation based on the target concatenation features corresponding to the multiple sub-audios to obtain target convolution features corresponding to the multiple sub-audios; calculate a maximum feature value and an average feature value that are corresponding to each feature dimension in the target convolution features based on the target convolution features corresponding to the multiple sub-audios; calculate a sum of the maximum feature value and the average feature value to obtain a semantic extraction feature value corresponding to each feature dimension in the target convolution feature, and obtain, based on the semantic extraction feature value corresponding to each feature dimension in the target convolution feature, semantic extraction features corresponding to the multiple sub-audios; perform linear activation on the semantic extraction features corresponding to the multiple sub-audios to obtain audio semantic features corresponding to the multiple sub-audios; and perform binary classification and identification between a music type audio and a non-music type audio by using the audio semantic features corresponding to the multiple sub-audios, to obtain the possibility that the multiple sub-audios are of the music type.

In an embodiment, the audio data processing apparatus further includes:
a model processing module, configured to input the audio data into a music classification and identification model, and divide the audio data into multiple sub-audios by using the music classification and identification model; separately extract time domain features from the multiple sub-audios by using the music classification and identification model, the time domain features including an intermediate time domain feature and a target time domain feature, and separately extract frequency domain features from the multiple sub-audios, the frequency domain features including an intermediate frequency domain feature and a target frequency domain feature; perform, by using the music classification and identification model, feature fusion on intermediate time domain features corresponding to the multiple sub-audios and intermediate frequency domain features corresponding to the multiple sub-audios, to obtain the fusion features corresponding to the multiple sub-audios; and perform, by using the music classification and identification model, semantic feature extraction based on the target time domain features, the target frequency domain features, and the fusion features that are corresponding to the multiple sub-audios, to obtain audio semantic features corresponding to the multiple sub-audios, and perform music type classification and identification based on the audio semantic features, to obtain the possibility that the multiple sub-audios are of the music type.

In an embodiment, the music classification and identification model includes a time domain feature extraction branch network, a frequency domain feature extraction branch network, a feature fusion network, an audio semantic feature extraction network, and a classification and identification network. The model processing module is further configured to input the audio data into the music classification and identification model, and divide the audio data into multiple sub-audios by using the music classification and identification model; input the multiple sub-audios into the time domain feature extraction branch network to perform time domain feature extraction, to obtain an outputted intermediate time domain feature and target time domain feature; input the multiple sub-audios into the frequency domain feature extraction branch network to perform frequency domain feature extraction to obtain an outputted intermediate frequency domain feature and target frequency domain feature; input the intermediate time domain features corresponding to the multiple sub-audios and the intermediate frequency domain features corresponding to the multiple sub-audios into the feature fusion network to perform feature fusion, to obtain the fusion features corresponding to the multiple sub-audios; and input the target time domain features, the target frequency domain features, and the fusion features that are corresponding to the multiple sub-audios into the audio semantic feature extraction network to perform semantic feature extraction, to obtain the audio semantic features corresponding to the multiple sub-audios, and input the audio semantic features into the classification and identification network to perform music classification and identification, to obtain the possibility that the multiple sub-audios are of the music type.

In an embodiment, the audio data processing apparatus further includes:
a training module, configured to obtain training audio data and a corresponding training label; input the training audio data into an initial music classification and identification model, and divide the training audio data into multiple training sub-audios by using the initial music classification and identification model; separately extract initial time domain features from the multiple training sub-audios by using the initial music classification and identification model, the initial time domain features including an initial intermediate time domain feature and an initial target time domain feature, and separately extract initial frequency domain features from the multiple training sub-audios, the initial frequency domain features including an initial intermediate frequency domain feature and an initial target frequency domain feature; perform, by using the initial music classification and identification model, feature fusion on initial intermediate time domain features corresponding to the multiple training sub-audios and initial intermediate frequency domain features corresponding to the multiple training sub-audios, to obtain initial fusion features corresponding to the multiple training sub-audios; extract, by using the initial music classification and identification model, initial target time domain features, initial target frequency domain features, and the initial fusion features that are corresponding to the multiple training sub-audios, to obtain initial audio semantic features corresponding to the multiple training sub-audios, and perform music type classification and identification based on the initial audio semantic features, to obtain an initial possibility that the multiple training sub-audios are of the music type; perform classification loss calculation based on the initial possibility that the multiple training sub-audios are of the music type and the training label corresponding to the training audio data to obtain loss information, and reversely update the initial music classification and identification model based on the loss information to obtain an updated music classification and identification model; and use the updated music classification and identification model as an initial music classification and identification model, and perform the operation of obtaining training audio data and a corresponding training label until a training completion condition is reached, to obtain the music classification and identification model.

In an embodiment, the audio data processing apparatus further includes:
an audio-video set obtaining module, configured to obtain video segments corresponding to the music segments in the same-type music segment set, to obtain a video segment set; and concatenate the same-type music segment set and the video segment set to obtain a same-type audio-video set.

All or some of the modules in the foregoing audio data processing apparatus may be implemented by using software, hardware, and a combination thereof. The foregoing modules may be embedded in or independent of a processor in the computer device in a hardware form, or may be stored in a memory in the computer device in a software form, so that the processor invokes the software to execute operations corresponding to the foregoing modules.

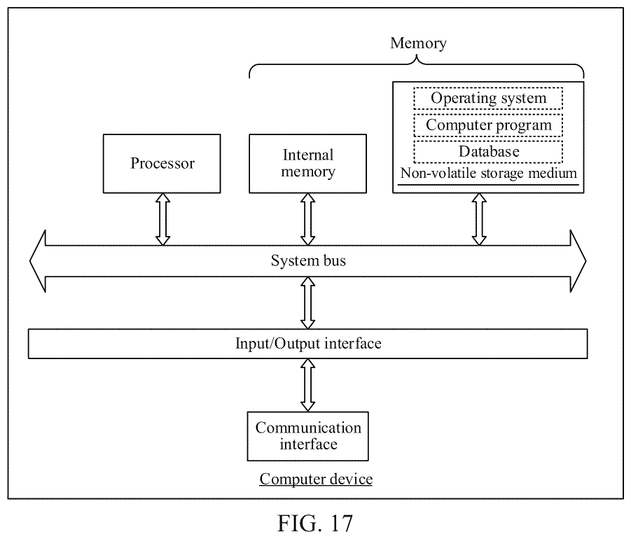

In an embodiment, a computer device is provided. The computer device may be a server, and an internal structure diagram of the computer device may be shown in FIG. 17. The computer device includes a processor, a memory, an input/output (I/O), and a communication interface. The processor, the memory, and the input/output interface are connected to each other by using a system bus, and the communication interface is connected to the system bus by using the input/output interface. The processor of the computer device is configured to provide a computing and control capability. The memory of the computer device includes a non-volatile storage medium and an internal memory. The non-volatile storage medium stores an operating system, computer readable instructions, and a database. The internal memory provides an environment for running an operating system and computer readable instructions in the non-volatile storage medium. A database of the computer device is configured to store audio data, video data, training data, and the like. The input/output interface of the computer device is configured to exchange information between the processor and an external device. The communication interface of the computer device is configured to communicate with an external terminal by using a network connection. The computer readable instructions are executed by the processor to implement an audio data processing method.

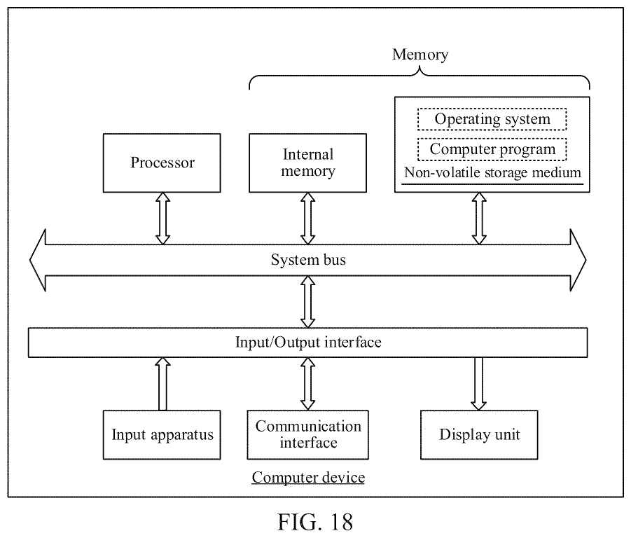

In an embodiment, a computer device is provided. The computer device may be a terminal, and an internal structure diagram of the computer device may be shown in FIG. 18. The computer device includes a processor, a memory, an input/output interface, a communication interface, a display unit, and an input apparatus. The processor, the memory, and the input/output interface are connected to each other by using a system bus, and the communication interface, the display unit, and the input apparatus are connected to the system bus by using the input/output interface. The processor of the computer device is configured to provide a computing and control capability. The memory of the computer device includes a non-volatile storage medium and an internal memory. The non-volatile storage medium stores an operating system and computer readable instructions. The internal memory provides an environment for running an operating system and computer readable instructions in the non-volatile storage medium. The input/output interface of the computer device is configured to exchange information between the processor and an external device. The communication interface of the computer device is configured to communicate with an external terminal in a wired or wireless manner. The wireless manner may be implemented by using Wi-Fi, a mobile cellular network, a near field communication (NFC), or another technology. The computer readable instructions are executed by the processor to implement an audio data processing method. The display unit of the computer device is configured to form a visual picture, and may be a display screen, a projection apparatus, or a virtual reality imaging apparatus. The display screen may be a liquid crystal display screen or an electronic ink display screen. The input apparatus of the computer device may be a touch layer covering the display screen, may be a key, a trackball, or a touchpad disposed on a housing of the computer device, or may be an external keyboard, touchpad, or mouse.

A person skilled in the art may understand that the structure shown in FIG. 17 or FIG. 18 is merely a block diagram of a partial structure related to the solutions of this application, and does not constitute a limitation on the computer device to which the solutions of this application are applied. A specific computer device may include more or fewer components than those shown in the figure, or combine some components, or have different component arrangements.

In an embodiment, a computer device is further provided, including a memory and a processor, where the memory stores computer readable instructions, and the processor implements steps in the foregoing method embodiments when executing the computer readable instructions.

In an embodiment, a computer readable storage medium is provided, where computer readable instructions are stored on the computer readable storage medium, and steps in the foregoing method embodiments are implemented when the computer readable instructions are executed by a processor.

In an embodiment, a computer program product is provided, including computer readable instructions, and the computer readable instructions are executed by a processor to implement steps in the foregoing method embodiments.

User information (including but not limited to user device information, user personal information, and the like) and data (including but not limited to data used for analysis, stored data, and displayed data) involved in this application are information and data that are authorized by a user or that are fully authorized by each party, and related data needs to be collected, used, and processed in compliance with relevant national laws and standards.

A person of ordinary skill in the art may understand that all or some of procedures of the method in the foregoing embodiments may be implemented by computer readable instructions instructing relevant hardware. The computer readable instructions may be stored in a non-volatile computer readable storage medium. When the computer readable instructions are executed, the procedures of the foregoing method embodiments may be implemented. Any reference to a memory, a database, or another medium used in the embodiments provided in this application may include at least one of a non-volatile memory and a volatile memory. The non-volatile memory may include a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a graphene memory, and the like. The volatile memory may include a random access memory (RAM), an external cache memory, or the like. As an illustration but not a limitation, the RAM may be in multiple forms, such as a static random access memory (SRAM) or a dynamic random access memory (DRAM). The database involved in the embodiments provided in this application may include at least one of a relational database and a non-relational database. The non-relational database may include a blockchain-based distributed database or the like, which is not limited thereto. The processor in the embodiments provided in this application may be a general purpose processor, a central processing unit, a graphics processor, a digital signal processor, a programmable logic device, a quantum computing-based data processing logic device, or the like, which is not limited thereto.

Technical features of the foregoing embodiments may be randomly combined. To make description concise, not all possible combinations of the technical features in the foregoing embodiments are described. However, the combinations of these technical features shall be considered as falling within the scope recorded by this specification provided that no conflict exists.

The foregoing embodiments merely express several implementations of this application. The descriptions thereof are relatively specific and detailed, but are not to be understood as limitations to the patent scope of this application. For a person of ordinary skill in the art, several transforms and improvements can be made without departing from the idea of this application. These transforms and improvements belong to the protection scope of this application. Therefore, the protection scope of this application shall be subject to the appended claims.

What is claimed is:

1. An audio data processing method performed by a computer device, comprising:
dividing audio data into multiple sub-audios;
separately extracting time domain features from the multiple sub-audios, the time domain features comprising an intermediate time domain feature and a target time domain feature;
separately extracting frequency domain features from the multiple sub-audios, the frequency domain features comprising an intermediate frequency domain feature and a target frequency domain feature;
performing feature fusion on intermediate time domain features corresponding to the multiple sub-audios and intermediate frequency domain features corresponding to the multiple sub-audios, to obtain fusion features corresponding to the multiple sub-audios;
performing semantic feature extraction based on target time domain features, target frequency domain features, and the fusion features that are corresponding to the multiple sub-audios, to obtain audio semantic features corresponding to the multiple sub-audios;
determining each music segment from the multiple sub-audios based on the audio semantic features corresponding to the multiple sub-audios and a music semantic feature corresponding to the music segment; and
performing music segment clustering based on the music semantic feature corresponding to each music segment, to obtain a same-type music segment set.

2. The method according to claim 1, wherein the method further comprises:
performing music type classification and identification based on the audio semantic features to obtain a music type for the multiple sub-audios.

3. The method according to claim 1, wherein the performing music segment clustering based on the music semantic feature corresponding to each music segment comprises:
separately performing sequence transform coding on the music semantic feature corresponding to each music segment to obtain an aggregation coding feature corresponding to each music segment;
performing sequence transform decoding by using the aggregation coding feature to obtain a target music semantic feature corresponding to each music segment; and
clustering each music segment according to the target music semantic feature corresponding to each music segment, to obtain the same-type music segment set.

4. The method according to claim 1, wherein the separately extracting time domain features from the multiple sub-audios, the time domain features comprising an intermediate time domain feature and a target time domain feature comprises:
separately performing a time domain convolution operation on the multiple sub-audios to obtain at least two intermediate convolution features corresponding to the multiple sub-audios and a final convolution feature;
performing frequency domain dimension transform on the at least two intermediate convolution features to obtain at least two intermediate time domain features corresponding to the multiple sub-audios; and
performing frequency domain dimension transform on the final convolution feature to obtain target time domain features corresponding to the multiple sub-audios.

5. The method according to claim 1, wherein the separately extracting frequency domain features from the multiple sub-audios, the frequency domain features comprising an intermediate frequency domain feature and a target frequency domain feature comprises:
extracting basic audio features corresponding to the multiple sub-audios; and
performing a frequency domain convolution operation on the basic audio features corresponding to the multiple sub-audios to obtain at least two intermediate frequency domain features and target frequency domain features corresponding to the multiple sub-audios.

6. The method according to claim 1, wherein the performing feature fusion on intermediate time domain features corresponding to the multiple sub-audios and intermediate frequency domain features corresponding to the multiple sub-audios, to obtain fusion features corresponding to the multiple sub-audios comprises:
concatenating a first intermediate time domain feature and a corresponding first intermediate frequency domain feature to obtain a first concatenation feature, and performing a convolution operation based on the first concatenation feature to obtain a first fusion feature; and
concatenating the first fusion feature, a second intermediate time domain feature, and a corresponding second intermediate frequency domain feature to obtain a second concatenation feature, and performing a convolution operation based on the second concatenation feature to obtain a fusion feature corresponding to the multiple sub-audios.

7. The method according to claim 1, wherein the method further comprises:
obtaining video segments corresponding to the music segments in the same-type music segment set, to obtain a video segment set; and
concatenating the same-type music segment set and the video segment set to obtain a same-type audio-video set.

8. A computer device comprising a memory and a processor, the memory storing computer readable instructions that, when executed by the processor, cause the computer device to perform an audio data processing method including:
dividing audio data into multiple sub-audios;
separately extracting time domain features from the multiple sub-audios, the time domain features comprising an intermediate time domain feature and a target time domain feature;
separately extracting frequency domain features from the multiple sub-audios, the frequency domain features comprising an intermediate frequency domain feature and a target frequency domain feature;
performing feature fusion on intermediate time domain features corresponding to the multiple sub-audios and intermediate frequency domain features corresponding to the multiple sub-audios, to obtain fusion features corresponding to the multiple sub-audios;
performing semantic feature extraction based on target time domain features, target frequency domain features, and the fusion features that are corresponding to the multiple sub-audios, to obtain audio semantic features corresponding to the multiple sub-audios;
determining each music segment from the multiple sub-audios based on the audio semantic features corresponding to the multiple sub-audios and a music semantic feature corresponding to the music segment; and
performing music segment clustering based on the music semantic feature corresponding to each music segment, to obtain a same-type music segment set.

9. The computer device according to claim 8, wherein the method further comprises:
performing music type classification and identification based on the audio semantic features to obtain a music type for the multiple sub-audios.

10. The computer device according to claim 8, wherein the performing music segment clustering based on the music semantic feature corresponding to each music segment comprises:
separately performing sequence transform coding on the music semantic feature corresponding to each music segment to obtain an aggregation coding feature corresponding to each music segment;
performing sequence transform decoding by using the aggregation coding feature to obtain a target music semantic feature corresponding to each music segment; and
clustering each music segment according to the target music semantic feature corresponding to each music segment, to obtain the same-type music segment set.

11. The computer device according to claim 8, wherein the separately extracting time domain features from the multiple sub-audios, the time domain features comprising an intermediate time domain feature and a target time domain feature comprises:
separately performing a time domain convolution operation on the multiple sub-audios to obtain at least two intermediate convolution features corresponding to the multiple sub-audios and a final convolution feature;
performing frequency domain dimension transform on the at least two intermediate convolution features to obtain at least two intermediate time domain features corresponding to the multiple sub-audios; and
performing frequency domain dimension transform on the final convolution feature to obtain target time domain features corresponding to the multiple sub-audios.

12. The computer device according to claim 8, wherein the separately extracting frequency domain features from the multiple sub-audios, the frequency domain features comprising an intermediate frequency domain feature and a target frequency domain feature comprises:
extracting basic audio features corresponding to the multiple sub-audios; and
performing a frequency domain convolution operation on the basic audio features corresponding to the multiple sub-audios to obtain at least two intermediate frequency domain features and target frequency domain features corresponding to the multiple sub-audios.

13. The computer device according to claim 8, wherein the performing feature fusion on intermediate time domain features corresponding to the multiple sub-audios and intermediate frequency domain features corresponding to the multiple sub-audios, to obtain fusion features corresponding to the multiple sub-audios comprises:
concatenating a first intermediate time domain feature and a corresponding first intermediate frequency domain feature to obtain a first concatenation feature, and performing a convolution operation based on the first concatenation feature to obtain a first fusion feature; and
concatenating the first fusion feature, a second intermediate time domain feature, and a corresponding second intermediate frequency domain feature to obtain a second concatenation feature, and performing a convolution operation based on the second concatenation feature to obtain a fusion feature corresponding to the multiple sub-audios.

14. The computer device according to claim 8, wherein the method further comprises:
obtaining video segments corresponding to the music segments in the same-type music segment set, to obtain a video segment set; and
concatenating the same-type music segment set and the video segment set to obtain a same-type audio-video set.

15. A non-transitory computer readable storage medium, storing computer readable instructions that, when executed by a processor of a computer device, cause the computer device to perform an audio data processing method including:
dividing audio data into multiple sub-audios;
separately extracting time domain features from the multiple sub-audios, the time domain features comprising an intermediate time domain feature and a target time domain feature;
separately extracting frequency domain features from the multiple sub-audios, the frequency domain features comprising an intermediate frequency domain feature and a target frequency domain feature;
performing feature fusion on intermediate time domain features corresponding to the multiple sub-audios and intermediate frequency domain features corresponding to the multiple sub-audios, to obtain fusion features corresponding to the multiple sub-audios;
performing semantic feature extraction based on target time domain features, target frequency domain features, and the fusion features that are corresponding to the multiple sub-audios, to obtain audio semantic features corresponding to the multiple sub-audios;
determining each music segment from the multiple sub-audios based on the audio semantic features corresponding to the multiple sub-audios and a music semantic feature corresponding to the music segment; and
performing music segment clustering based on the music semantic feature corresponding to each music segment, to obtain a same-type music segment set.

16. The non-transitory computer readable storage medium according to claim 15, wherein the method further comprises:
performing music type classification and identification based on the audio semantic features to obtain a music type for the multiple sub-audios.

17. The non-transitory computer readable storage medium according to claim 15, wherein the performing music segment clustering based on the music semantic feature corresponding to each music segment comprises:
separately performing sequence transform coding on the music semantic feature corresponding to each music segment to obtain an aggregation coding feature corresponding to each music segment;
performing sequence transform decoding by using the aggregation coding feature to obtain a target music semantic feature corresponding to each music segment; and
clustering each music segment according to the target music semantic feature corresponding to each music segment, to obtain the same-type music segment set.

18. The non-transitory computer readable storage medium according to claim 15, wherein the separately extracting time domain features from the multiple sub-audios, the time domain features comprising an intermediate time domain feature and a target time domain feature comprises:
separately performing a time domain convolution operation on the multiple sub-audios to obtain at least two intermediate convolution features corresponding to the multiple sub-audios and a final convolution feature;
performing frequency domain dimension transform on the at least two intermediate convolution features to obtain at least two intermediate time domain features corresponding to the multiple sub-audios; and
performing frequency domain dimension transform on the final convolution feature to obtain target time domain features corresponding to the multiple sub-audios.

19. The non-transitory computer readable storage medium according to claim 15, wherein the separately extracting frequency domain features from the multiple sub-audios, the frequency domain features comprising an intermediate frequency domain feature and a target frequency domain feature comprises:
extracting basic audio features corresponding to the multiple sub-audios; and
performing a frequency domain convolution operation on the basic audio features corresponding to the multiple sub-audios to obtain at least two intermediate frequency domain features and target frequency domain features corresponding to the multiple sub-audios.

20. The non-transitory computer readable storage medium according to claim 15, wherein the method further comprises:
obtaining video segments corresponding to the music segments in the same-type music segment set, to obtain a video segment set; and
concatenating the same-type music segment set and the video segment set to obtain a same-type audio-video set.
